(19) United States
(12) Patent Application Publication
(10) Pub. No.: US 2025/0052962 A1
(43) Pub. Date: Feb. 13, 2025

(54) PHOTONIC ASSEMBLY INCLUDING AN EMBEDDED OPTICAL CONNECTOR DIE AND METHODS FOR FORMING THE SAME

(71) Applicant: Taiwan Semiconductor Manufacturing Company Limited, Hsinchu (TW)

(72) Inventors: Chen-Hua Yu, Hsinchu City (TW); Hsing-Kuo Hsia, Jhubei City (TW); Chih-Wei Tseng, Hsinchu City (TW); Jiun Yi Wu, Jiun Yi (TW)

(21) Appl. No.: 18/402,016

(22) Filed: Jan. 2, 2024

Related U.S. Application Data
(60) Provisional application No. 63/613,070, filed on Dec. 21, 2023.
(60) Provisional application No. 63/518,154, filed on Aug. 8, 2023.

(51) Int. Cl. G02B 6/42

(52) U.S. Cl. CPC G02B 6/4214; G02B 6/4257; G02B 6/4283

(57) ABSTRACT

A photonic assembly includes a composite die. The composite die includes: a photonic integrated circuits (PIC) die including waveguides and photonic devices therein; an electronic integrated circuits (EIC) die including semiconductor devices therein; and an embedded optical connector die contacting a top surface of the PIC die and laterally spaced from the EIC die.

### RELATED APPLICATIONS

This application claims the benefit of priority from U.S. Provisional Application Ser. No. 63/613,070, entitled “Photonic Assembly Including An Embedded Optical Connector Die And Methods For Forming The Same,” filed on Dec. 21, 2023, and U.S. Provisional Application Ser. No. 63/518,154, entitled “Integration of Interior Optical Connector Die for Channeling CPO Architecture and Fiber(s) for COUPE 2.0 Architecture,” filed on Aug. 8, 2023, the entire contents of both of which are incorporated herein by reference for all purposes.

### BACKGROUND

Photonic integrated circuits (PICs) and electronic integrated circuits (EICs) are extensively used in modern electronics. PICs include photonic components formed in a photonic die, and electronic integrated circuits include semiconductor devices formed in a semiconductor die. PICs rely on light energy, and are supported by laser sources that enhance integration, speed, and heat reduction. The fabrication of PICS may use monolithic photonic integration or hybrid photonic integration. The utility of PICs spans across applications such as automotive sensors, healthcare systems, and data communication. PICs offer advantages such as energy efficiency, high speed, and integration compatibility with electronic integrated circuits.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a vertical cross-sectional view of a first embodiment structure of the present disclosure according to an aspect of the present disclosure. FIG. 1B is a magnified view of a portion of the first embodiment structure of FIG. 1A. FIGS. 1C-1F are vertical cross-sectional views of various alternative configurations of the first embodiment structure.

FIG. 2A is a vertical cross-sectional view of a first embodiment of a reflector mirror according to an aspect of the present disclosure. FIG. 2B is a vertical cross-sectional view of a second embodiment of a reflector mirror according to an aspect of the present disclosure.

FIG. 3A is a vertical cross-sectional view of a second embodiment structure of the present disclosure according to an aspect of the present disclosure. FIG. 3B is a magnified view of a portion of the first embodiment structure of FIG. 3A. FIGS. 3C-3F are vertical cross-sectional views of various alternative configurations of the second embodiment structure.

FIG. 4A is a vertical cross-sectional view of a third embodiment structure of the present disclosure according to an aspect of the present disclosure. FIG. 4B is a magnified view of a portion of the first embodiment structure of FIG. 4A. FIGS. 4C-4F are vertical cross-sectional views of various alternative configurations of the third embodiment structure.

FIG. 5A is a vertical cross-sectional view of a fourth embodiment structure of the present disclosure according to an aspect of the present disclosure. FIG. 5B is a magnified view of a portion of the first embodiment structure of FIG. 5A. FIGS. 5C-5F are vertical cross-sectional views of various alternative configurations of the fourth embodiment structure.

FIG. 6A is a vertical cross-sectional view of a fifth embodiment structure of the present disclosure according to an aspect of the present disclosure. FIG. 6B is a magnified view of a portion of the first embodiment structure of FIG. 6A. FIGS. 6C-6F are vertical cross-sectional views of various alternative configurations of the fifth embodiment structure.

FIG. 7A is a vertical cross-sectional view of a sixth embodiment structure of the present disclosure according to an aspect of the present disclosure. FIG. 7B is a magnified view of a portion of the first embodiment structure of FIG. 7A. FIGS. 7C-7F are vertical cross-sectional views of various alternative configurations of the sixth embodiment structure.

FIG. 8A is a vertical cross-sectional view of a seventh embodiment structure of the present disclosure according to an aspect of the present disclosure. FIG. 8B is a magnified view of a portion of the first embodiment structure of FIG. 8A. FIGS. 8C-8F are vertical cross-sectional views of various alternative configurations of the seventh embodiment structure.

FIG. 9A is a vertical cross-sectional view of an eighth embodiment structure of the present disclosure according to an aspect of the present disclosure. FIG. 9B is a magnified view of a portion of the first embodiment structure of FIG. 9A. FIGS. 9C-9F are vertical cross-sectional views of various alternative configurations of the eighth embodiment structure.

FIG. 10 is a flowchart illustrating general processing steps for forming a photonic assembly of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Elements with the same reference numerals are presumed to be the same element or similar elements, and are presumed to have the same material composition and provide the same function, unless expressly described otherwise.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Elements with the same reference numerals refer to the same element, and are presumed to have the same material composition and the same thickness range unless expressly indicated otherwise. As used herein, an element or a system “configured for” a function or an operation or “configured to” provide or perform a function or an operation refers to an element or a system that is provided with hardware, and with software as applicable, to provide such a function or such an operation as described in the present disclosure, and as known in the art in the event any details of such hardware or such software are not expressly described herein.

A compact universal photonic engine (COUPE) includes a combination of PICs and EICs that provides optical-electrical transmission. A COUPE allows for the processing of optical signals using an electronic signal transmission system. A COUPE integrates various optical components, electro-optics transition devices, and optical fibers. In optical-electrical devices, laser light plays a pivotal role. Optical fibers may be used to feed laser light to a COUPE. The laser light may pass through a supporting silicon substrate. The laser light may be re-focused and re-concentrated through optical lenses to reduce spatial light divergence.

According to an aspect of the present disclosure, the COUPE may include optical elements for effectively channeling of the laser light (also referred simply as light) to optical devices in a die. Specifically, an electronic integrated circuit (EIC) die and an embedded optical connector die are bonded to a photonic integrated circuits (PIC) die to form a composite die. A dielectric matrix may laterally surround the EIC die and the embedded optical connector die to form a composite die. A support semiconductor substrate may be attached to an assembly of the EIC die, the embedded optical connector die, and the dielectric matrix. The embedded optical connector die comprises an optical deflector that may deflect horizontally-propagating photons along a vertical direction and/or may deflect vertically-propagating photons along a horizontal direction.

Various embodiments disclosed herein may provide a versatile embedded optical connector die located within a COUPE die. The optical connector functions as an optical conduit between external optical fibers or light coupler apparatus and the waveguides within the composite die which functions as a COUPE die. The optical deflector within the embedded optical connector die of the various embodiments may provide flexible channeling of the light between photonic integrated circuits (PICs) and the fibers or light coupler apparatus. Various embodiments of the present disclosure may provide diverse coupling modes for optical fibers or light coupler apparatus, encompassing both vertical and horizontal coupling styles. Embodiments of the present disclosure may be used in such fields as photonic integrated circuits, silicon photonics, three-dimensional integrated chips with photonics applications, and/or the COUPE technology in general.

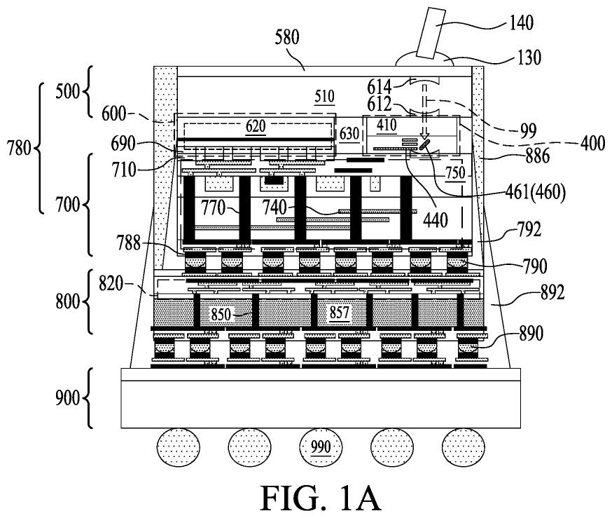

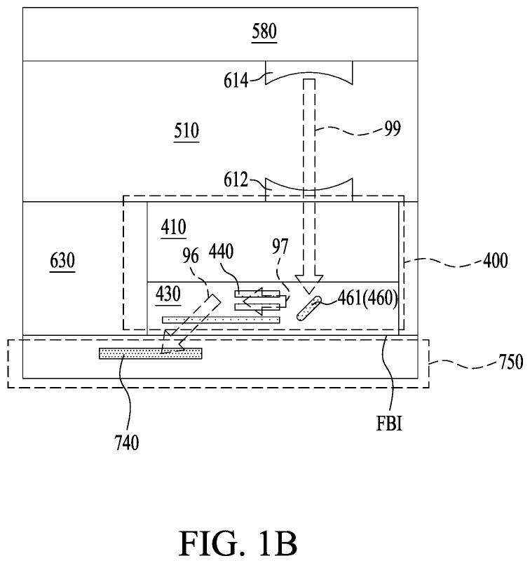

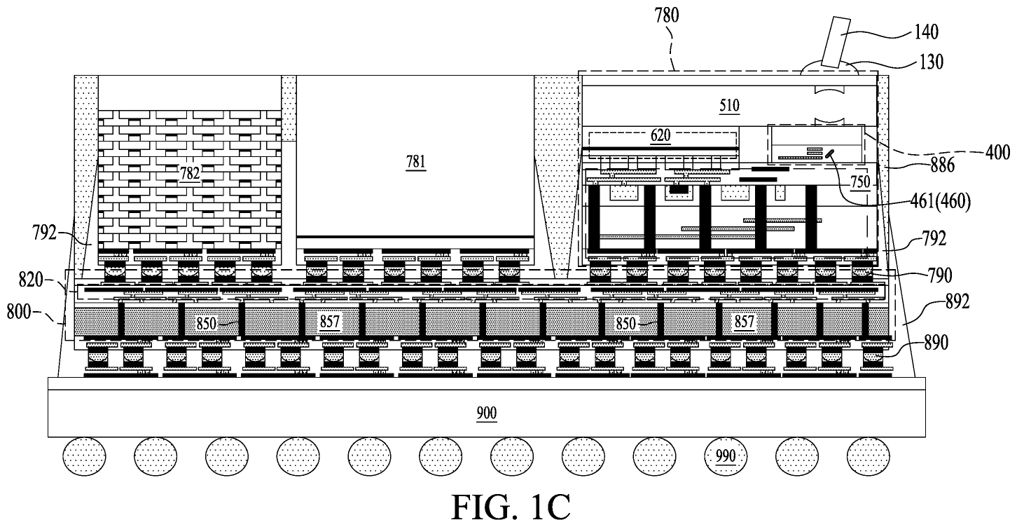

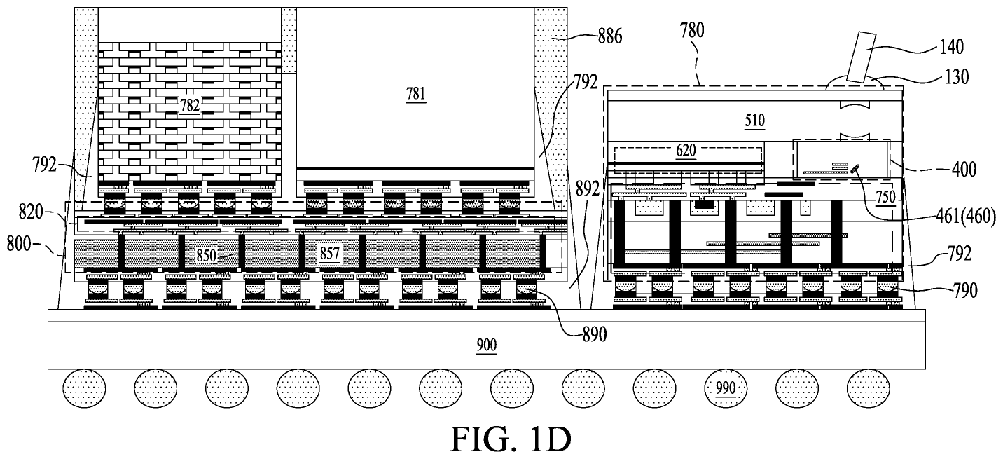

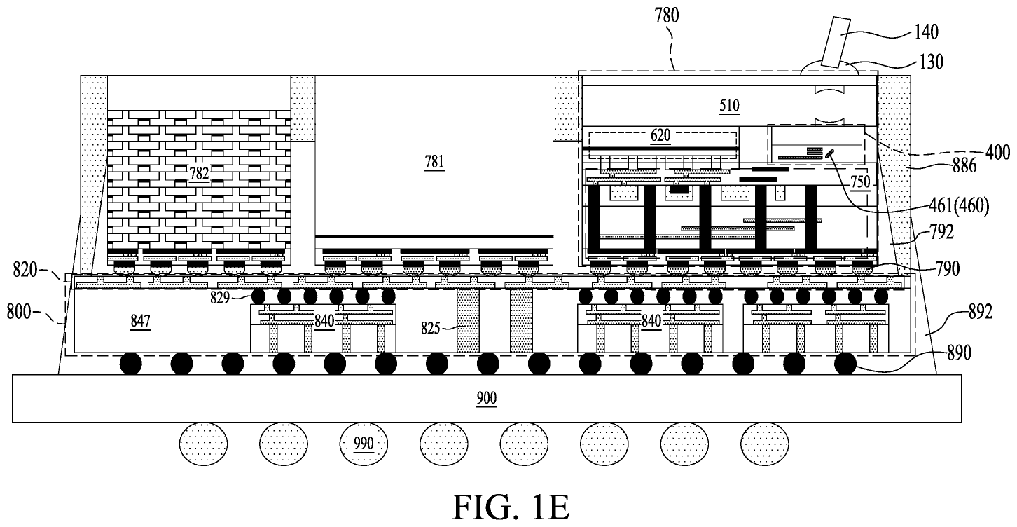

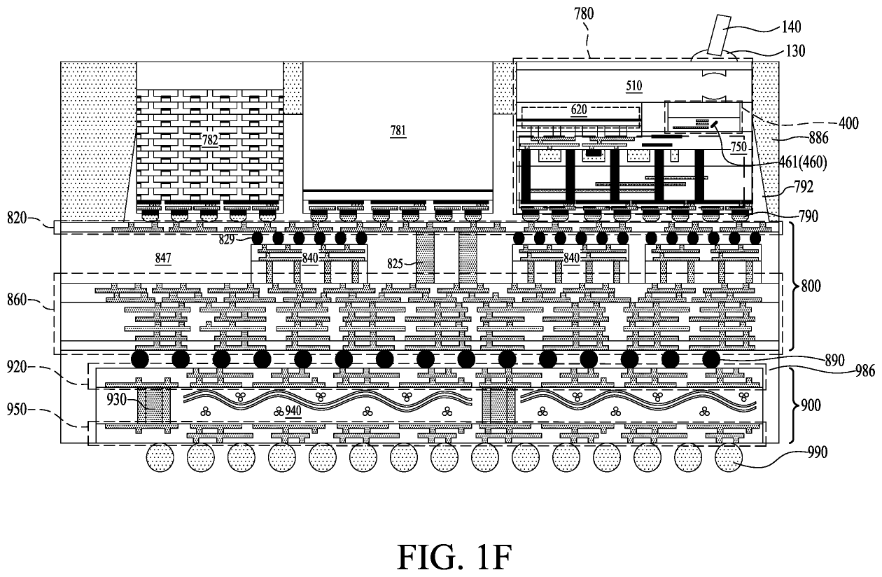

FIG. 1B is a magnified view of a portion of the first embodiment structure of FIG. 1A. FIGS. 1C-1F are vertical cross-sectional views of various alternative configurations of the first embodiment structure.

Referring to FIGS. 1A and 1B, the first embodiment structure comprises an optical assembly including a composite die 780. The composite die 780 comprises a compact universal photonic engine (COUPE) (600, 700), which includes a combination of photonic integrated circuits provided in a photonic integrated circuits (PIC) die 700 and electronic integrated circuits provided in an electronic integrated circuits (EIC) die 600. The optical assembly generally include electro-optics transition devices and at least one optical fiber 140 that provides light.

The composite die 780 may be formed by providing a PIC die 700 and an EIC die 600. The PIC die 700 comprises various types of photonic devices 750 known in the art, and waveguides 740 providing optical paths between optical nodes of the various photonic devices 750, and metal interconnect structures 770 configured to provide electrical signals to the various electrical nodes of the photonic devices 750. A top side of the PIC die 700 may comprise metallic bonding pads configured for metal-to-metal bonding (such as copper-to-copper bonding), which are herein referred to as PIC metallic bonding pads 710. A bottom side of the PIC die 700 may comprise on-die bump structures 788, i.e., bump structures that are formed on a die. The on-die bump structures 788 may comprise microbump structures (i.e. C2 bump structures) or C4 bump structures. The metal interconnect structures 770 within the PIC die 700 provide electrical connection between the PIC metallic bonding pads 710 and the on-die bump structures 788. In some embodiments, the PIC die 700 may be made from a semiconductor-on-insulator (SOI) wafer. Generally, an array of PIC dies 700 may be provided as a two-dimensional periodic array of PIC dies 700 within a wafer.

The EIC die 600 comprises semiconductor devices 620 that form the electronic integrated circuits. The semiconductor devices 620 may comprise field effect transistors, diodes, resistors, capacitors, inductors, or various other types of semiconductor devices that may be manufactured on a semiconductor substrate. Further, metal interconnect structures (not expressly shown) embedded within dielectric material layers including interlayer dielectric (ILD) materials) may be provided in the EIC die 600. In addition, the EIC die may comprise metallic bonding pads configured for metal-to-metal bonding, which are herein referred to as EIC metallic bonding pads 690. The EIC metallic bonding pads 690 may be arranged in a mirror image pattern of the pattern of the PIC metallic bonding pads 710. According to an aspect of the present disclosure, the EIC die 600 may have a smaller lateral extent than the PIC die 700. Thus, the EIC die 600 may fit within the area of the PIC die 700 in a plan view upon aligning the EIC die 600 with the PIC die 700 for metal-to-metal bonding between the PIC metallic bonding pads 710 and the EIC metallic bonding pads 690.

The EIC die 600 may be attached to the PIC die 700, for example, by bonding the EIC metallic bonding pads 690 to the PIC metallic bonding pads 710 through metal-to-metal bonding, such as copper-to-copper bonding). In embodiments in which a wafer including a two-dimensional array of PIC dies 700 is provided, a plurality of EIC dies 600 may be bonded to a respective PIC die 700 within the two-dimensional array of PIC dies 700.

An optical connector die 400 is provided. The optical connector die 400 comprises a die substrate 410 (which may comprise a semiconductor material such as silicon), and dielectric material layers 430 embedding an optical deflector 460 (such as an in-die mirror 461) and waveguides 440 that laterally extend along a horizontal direction and optically coupled to the optical deflector 460. In some embodiments, the in-die mirror 461 may be replaced with a grating coupler. The optical deflector 460 is configured to deflect a beam between a vertically-extending beam path 99 (which comprises a vertically-extending portion of the entire beam path) that vertically extends through the die substrate 410 and a horizontally-extending beam path 97 that laterally extends through a subset of the waveguides 440 within the optical connector die 400. The optical connector die 400 may be bonded to the top surface of the PIC die 700 prior to, or after, bonding the EIC die 600 to the PIC die 700. In one embodiment, the optical connector die 400 may be bonded to the PIC die 700 through fusion of dielectric materials at surface portions of the PIC die 700 and the optical connector die 400. In this embodiment, a fusion bonding interface (FBI) may be formed at the interface between the PIC die 700 and the optical connector die 400. Optical beams in the waveguides 440 within the embedded optical connector die 400 may be optically coupled to the waveguides 740 in the PIC die 700 through evanescent coupling. An inter-die optical beam path 96 is schematically illustrated in FIG. 1B.

A dielectric fill material such as a molding compound material, a polymer material, or a silicon oxide material (such as flowable oxide) may be deposited in the gaps between neighboring pairs of EIC dies 600 over the wafer including the two-dimensional array of PIC dies 700. A planarization process such as a chemical mechanical polishing process may be performed to remove portions of the dielectric fill material from above the horizontal plane including the top surfaces of the EIC dies 600. The remaining portion of the dielectric fill material comprises a dielectric matrix 630. The dielectric matrix 630 may laterally surround the EIC die 600 and the optical connector die 400. Thus, the optical connector die 400 becomes embedded within the dielectric matrix 630, and is hereafter referred to as an embedded optical connector die 400. In one embodiment, the EIC die 600, the embedded optical connector die 400, and the dielectric matrix 630 may have the same thickness.

A semiconductor layer including optical lenses (612, 614) may be attached to the top surface of a reconstituted wafer including a two-dimensional array of PIC dies 700, a two-dimensional array of EIC dies 600, and the dielectric matrices 630. The semiconductor layer is used as a support structure, and is herein referred to as a support semiconductor substrate 510. Thus, the support semiconductor substrate 510 may be formed over the EIC die 600, the embedded optical connector die 400, and the dielectric matrix 630. The optical lenses (612, 614) may be formed, for example, by forming recess cavities including non-planar surfaces (such as convex surfaces) in the path of an optical beam, such as a vertically-extending beam path 99, and by filing the recess cavities by an optically transparent material such as silicon oxide. The optical lenses (612, 614) may comprise first substrate lenses 612 (which are also referred to as proximal substrate lenses) that are formed on a proximal side of the support semiconductor substrate 510 (i.e., a side that is proximal to the PIC die 700), and second substrate lenses 614 (which are also referred to as distal substrate lenses) that are formed on a distal side of the support semiconductor substrate 510 (i.e., a side that is distal from the PIC die 700). The optical lenses (612, 614) may be used to focus a light beam that travels through the support semiconductor substrate 510.

Through-substrate via structures (not shown) may be optically formed through the support semiconductor substrate 510 to provide vertically-extending electrically conductive paths, which may be used to provide additional electrical connections to the electrical nodes of the semiconductor devices 620. The support semiconductor substrate 510 may be bonded to the combination of the array of EIC dies 600 and the dielectric matrices 630 by semiconductor-to-insulator bonding (such as silicon-to-oxide bonding or silicon-to-polymer bonding), or a thin layer of semiconductor oxide layer (not shown) may be formed on a bottom surface of the support semiconductor substrate 510, for example, by oxidation, and oxide-to-insulator bonding may be used. A suitable thermal anneal at an elevated temperature may be used to bond the support semiconductor substrate 510 to the combination of the array of EIC dies 600 and the dielectric matrices 630. The thickness of the support semiconductor substrate 510 may be in a range from 5 microns to 30 microns, although lesser and greater thicknesses may also be used.

An optically transparent dielectric layer 580 may be deposited on a top surface of the support semiconductor substrate 510. The optically transparent dielectric layer 580 may include a polymer or silicon oxide. The thickness of the optically transparent dielectric layer 580 may be in a range from 1 micron to 10 microns, although lesser and greater thicknesses may also be used. The combination of the support semiconductor substrate 510 and the optically transparent dielectric layer 580 constitutes a substrate 500. As used herein, an optically transparent element refers to an element having an optical extinction coefficient (i.e., an imaginary part of a refractive index) less than 0.0001 within the wavelength range of the light used in optical communication, such as a wavelength range from 500 nm to 2,000 nm.

The reconstituted wafer including the two-dimensional array of PIC dies 700, the two-dimensional array of EIC dies 600, the two-dimensional array of embedded optical connector dies 400, the dielectric matrices 630, and the substrate 500 may be diced along dicing channels to form a plurality of composite dies 780. Thus, each composite die 780 comprises a respective PIC die 700, a respective EIC die 600, a respective embedded optical connector die 400, a respective dielectric matrix 630, a respective support semiconductor substrate 510, and a respective optically transparent dielectric layer 580. Within each composite die 780, sidewalls of the PIC die 700 may be vertically coincident with sidewalls of the dielectric matrix 630, sidewalls of the support semiconductor substrate 510, and sidewalls of the optically transparent dielectric layer 580, and may be vertically coincident with a sidewall of the EIC die 600. As used herein, a first surface is vertically coincident with a second surface in instances in which the second surface overlies or underlies the first surface and in instances in which there exists a vertical plane including the first surface and the second surface.

The composite die 780 may be bonded to an interposer wafer including a two-dimensional array of interposers 800. Each interposer 800 may comprise, for example, through-interposer via structures 850 vertically extending through an interposer matrix 857, metal interconnect wing 820 providing electrically conductive paths, die-side bump structures having a mirror image pattern of the on-die bump structures 788 and facing the composite die 780, and substrate-side bump structures located on an opposite side of the die-side bump structures. In some embodiments, the substrate-side bump structures may comprise C4 bonding pads.

Composite dies 780 may be bonded to a respective one of the interposers 800 in the interposer wafer using arrays of first solder material portions 790. A first underfill material portion 792 may be applied around each array of first solder material portions 790 between a respective bonded pair of a composite die 780 and an interposer 800. A molding compound material may be applied to the gaps between neighboring pairs of composite dies 780. Excess portions of the molding compound material may be removed from above the horizontal plane including top surfaces of the composite dies 780 by a planarization process such as a chemical mechanical polishing process. The remaining portion of molding compound material constitutes a molding compound matrix. A reconstituted wafer including the interposer wafer, the array of composite dies 780, and the molding compound matrix may be diced along dicing channels to form a bonded assembly (780, 800, 886) including a composite die 780, and interposer 800, and a molding compound die frame 886. Sidewalls of the molding compound die frame 886 may be vertically coincident with sidewall of the packaging substrate 900.

The bonded assembly (780, 800, 886) may be bonded to a packaging substrate 900 through an array of second solder material portions 890. The second solder material portions 890 may comprise microbump solder balls or C4 solder balls. A second underfill material portion 892 may be formed around the second solder material portions 890 between the interposer 800 and the packaging substrate 900. The optical connector unit 100 may be attached to the composite die 780 prior to, or after, attaching solder joints 990 to the packaging substrate 900.

The bonded assembly (780, 800, 886) may comprise a photonic assembly (i.e., an assembly including photonic devices therein) including the composite die 780. The composite die 780 comprises at least one optical path that includes a vertically-extending beam path 99 that extends from an optical deflector 460 embedded within the PIC die 700 through the dielectric matrix 630, through the support semiconductor substrate 510 and at least one optical lens (612, 614) thereupon, and into the optically transparent dielectric layer 580.

At least one optical fiber 140 may be attached to a portion of a top surface of the composite die 780 that intersects the vertically-extending beam path 99. For example, the at least one optical fiber 140 may be attached to portion of the top surface of the optically transparent dielectric layer 580 that intersects the vertically-extending beam path 99. In some embodiments, the optical deflector 460 may be elongated along a horizontal direction (such as a horizontal direction that is perpendicular to the vertical cut plane of the cross-sectional views FIGS. 1A and 1B), and a plurality of optical fibers 140 may be attached to the top surface of the composite die 780.

FIGS. 1C-1F are vertical cross-sectional views of various alternative configurations of the first embodiment structure.

Referring to FIG. 1C, a first alternative configuration of the first embodiment structure may be derived from the first embodiment structure illustrated in FIGS. 1A and 1B by using an interposer 800 having a greater lateral extent than the composite die 780, and by attaching additional semiconductor dies (781, 782) such as an application-specific integrated circuit (ASIC) die 781 and a memory die 782 to the interposer 800 through additional arrays of first solder material portions 790. In one embodiment, an additional first underfill material portion 792 may be formed around the additional semiconductor dies (781, 782), and the molding compound die frame 886 may laterally surround the composite die 780 and the additional semiconductor dies (781, 782). Sidewalls of the molding compound die frame 886 may be vertically coincident with sidewalls of the interposer 800. The optical connector unit 100 may be attached to the composite die 780 prior to, or after, attaching the solder joints 990 to the packaging substrate 900. The at least one optical fiber 140 may be attached to the composite die 780 prior to, or after, attaching solder joints 990 to the packaging substrate 900.

Referring to FIG. 1D, a second alternative configuration of the first embodiment structure may be derived form the first embodiment structure illustrated in FIGS. 1A and 1B by using a packaging substrate 900 having a greater lateral extent than the composite die 780, by attaching the composite die 780 to the packaging substrate 900 by using an array of first solder material portions 790, and by forming a first underfill material portion around the array of first solder material portions 790. Additional semiconductor dies (781, 782) such as an application-specific integrated circuit (ASIC) die 781 and a memory die 782 may be attached to an interposer 800 through additional arrays of first solder material portions 790. In one embodiment, an additional first underfill material portion 792 may be formed around the additional semiconductor dies (781, 782), and a molding compound die frame 886 may be formed around the additional semiconductor dies (781, 782). Sidewalls of the molding compound die frame 886 may be vertically coincident with sidewalls of the interposer 800. The interposer 800 may be attached to the packaging substrate 900 through an array of second solder material portions 890. A second underfill material portion 892 may be formed around the combination of the additional semiconductor dies (781, 782), the interposer 800, and the molding compound die frame 886. The combination of the additional semiconductor dies (781, 782), the interposer 800, and the molding compound die frame 886 may be located adjacent to the composite die 780 over the packaging substrate 900. The optical fiber 140 may be attached to the composite die 780 prior to, or after, attaching solder joints 990 to the packaging substrate 900.

Referring to FIG. 1E, a third alternative configuration of the first embodiment structure may be derived from the first configuration of the sixth embodiment structure illustrated in FIGS. 1A and 1B by using a composite interposer including at least one embedded local interconnect die 840 as the interposer 800. In this embodiment, the interposer 800 may comprise at least one embedded local interconnect die 840 (such as silicon interconnect dies including a silicon substrate, through-substrate via structures, and metal interconnect structures embedded in dielectric material layers), through-interposer via structures 825 located adjacent to, and/or between, the at least one embedded local interconnect die 840, an interposer molding compound frame 847 embedding the at least one embedded local interconnect die 840 and the through-interposer via structures 825, and metal interconnect wiring 820 that is electrically connected to the at least one embedded local interconnect dies 840 through microbump structures 829 and eclectically connected to the through-interposer via structures 825. The composite die 780 and the additional semiconductor dies (781, 782) may be attached to the interposer 800 through a respective array of first solder material portions 790. A first underfill material portion 792 may laterally surround the arrays of first solder material portions 790. A molding compound die frame 886 may laterally surround composite die 780 and the additional semiconductor dies (781, 782). Sidewalls of the molding compound die frame 886 may be vertically coincident with sidewalls of the interposer 800. The assembly of the interposer 800, the composite die 780, the additional semiconductor dies (781, 782), and the molding compound die frame 886 may be attached to the packaging substrate 900 through an array of second solder material portions 890. A second underfill material portion 892 may laterally surround the array of second solder material portions 890. The optical fiber 140 may be attached to the composite die 780 prior to, or after, attaching solder joints 990 to the packaging substrate 900.

Referring to FIG. 1E, a fourth alternative configuration of the first embodiment structure may be derived from the first embodiment structure illustrated in FIGS. 1A and 1B by using a composite interposer including additional metal interconnect wiring 860 as the interposer 800. In this embodiment, the interposer 800 may comprise at least one embedded local interconnect die 840 (such as silicon interconnect dies including a silicon substrate, through-substrate via structures, and metal interconnect structures embedded in dielectric material layers), through-interposer via structures 825 located adjacent to, and/or between, the at least one embedded local interconnect die 840, an interposer molding compound frame 847 embedding the at least one embedded local interconnect die 840 and the through-interposer via structures 825, die-side metal interconnect wiring 820 that is electrically connected to the at least one embedded local interconnect dies 840 through microbump structures 829 and eclectically connected to the through-interposer via structures 825, and package-side metal interconnect wiring 860 located on an opposite side of the die-side metal interconnect wiring 820.

The composite die 780 and the additional semiconductor dies (781, 782) may be attached to the interposer 800 through a respective array of first solder material portions 790. A first underfill material portion 792 may laterally surround the arrays of first solder material portions 790. A molding compound die frame 886 may laterally surround composite die 780 and the additional semiconductor dies (781, 782). Sidewalls of the molding compound die frame 886 may be vertically coincident with sidewalls of the interposer 800. A wafer including a two-dimensional array of interposers 800 may be provided, and a set of a composite die 780 and additional semiconductor dies (781, 782) may be attached to each interposer 800. A first underfill material portion 792 may be formed around each set of a composite die 780 and additional semiconductor dies (781, 782) that is formed over an interposer 800 within the two-dimensional array of interposer 800. A first molding compound material may be formed over the wafer including the two-dimensional array of interposer 800, and may be planarized to form a first molding compound matrix.

Packaging substrates 900 may be attached to a respective one of the interposers 800 through a respective array of second solder material portions 890. Each packaging substrate 900 may have a lesser area than the interposer 800 to which the packaging substrate 900 is attached. Each packaging substrate 900 may comprise die-side interconnection traces 920 located on a die side and board-side interconnection traces 950 located on a board side. Further, each packaging substrate 900 may comprise through-substrate via structures 930 embedded within an insulating substrate 940 and providing electrical connection between the die-side interconnection traces 920 and the board-side interconnection traces 950. A second molding compound material may be formed under the wafer including the two-dimensional array of interposer 800, and may be planarized to form a second molding compound matrix.

The combination of the wafer, a two-dimensional array of sets of dies (780, 781, 782), a two-dimensional array of packaging substrates 900, the first molding compound matrix, and the second molding compound matrix may be diced along dicing channels to form photonic assemblies. Each photonic assembly comprises a composite die 780, additional semiconductor dies (781, 782), a first underfill material portion 792, a molding compound die frame 886 that is a diced portion of the first molding compound matrix, a packaging substrate 900, and a molding compound substrate frame 986 which is a diced portion of the second molding compound matrix. The at least one optical fiber 140 may be attached to the composite die 780 prior to, or after, attaching solder joints 990 to the packaging substrate 900.

Generally, a photonic integrated circuits (PIC) die 700 comprising waveguides 740 and photonic devices 750 therein may be provided. An electronic integrated circuits (EIC) die 600 comprising semiconductor devices 620 therein may be bonded to the PIC die 700. An optical connector die 400 comprising an optical element (such as an optical deflector 460) may be attached to the PIC die 700. A dielectric matrix 630 may be formed around the optical connector die 400 directly on a sidewall of the EIC die 600. A support semiconductor substrate 510 may be attached to an assembly including the EIC die 600, the embedded optical connector die 400, and the dielectric matrix 630. The support semiconductor substrate 510 overlies the EIC die 600 and the embedded optical connector die 400. In one embodiment, the embedded optical connector die 400 contacts a bottom surface of the support semiconductor substrate 510. A composite die 780 may be formed.

In some embodiments, a first optical lens 612 may be embedded on a first side of the support semiconductor substrate 510 that faces the assembly (700, 600, 400, 630). In some embodiments, a second optical lens 614 may be embedded on a second side of the support semiconductor substrate 510 that is an opposite side of the first side. In some embodiment, the optical element in the embedded optical connector die 400 comprises an optical deflector 460 that is configured to change a beam direction between a vertically-extending beam path 99 within the composite die 780 and a horizontally-extending beam path 97 within a first waveguide 440 in the embedded optical connector die 400. The vertically-extending beam path 99 extends through the support semiconductor substrate 510.

Referring collectively to FIGS. 1A-1F, a photonic assembly comprising a composite die 780 is provided. The composite die 780 comprises: a photonic integrated circuits (PIC) die 700 comprising waveguides 740 and photonic devices 750 therein; an electronic integrated circuits (EIC) die 600 comprising semiconductor devices 620 therein; and an embedded optical connector die 400 contacting a top surface of the PIC die 700 and laterally spaced from the EIC die 600. In one embodiment, the vertically-extending beam path 99 is located entirely outside, and above, the PIC die 700. An optical deflector 460 in the embedded optical connector die 400 may be configured to change a beam direction between the vertically-extending beam path 99 and a horizontally-extending beam path 97 within a horizontally-extending waveguide in the PIC die 700.

According to an aspect of the present disclosure, the composite die 780 comprises: a photonic integrated circuits (PIC) die 700 comprising waveguides 740 and photonic devices 750 therein; an electronic integrated circuits (EIC) die 600 comprising semiconductor devices 620 therein; a support semiconductor substrate 510 overlying the PIC die 700 and the EIC die 600, wherein the composite die 780 is configured to provide a vertically-extending beam path 99 that extends through the support semiconductor substrate 510; and an embedded optical connector die 400 comprising an optical element located within, or at an end of, the vertically-extending beam path 99. In one embodiment, the optical element comprises an optical deflector 460 that is configured to change a beam direction between the vertically-extending beam path 99 within the composite die 780 and a horizontally-extending beam path 97 within a first waveguide in the embedded optical connector die 400.

In one embodiment, a top surface of the EIC die 600 contacts a first segment of a bottom surface of the support semiconductor substrate 510; and a top surface of the embedded optical connector die 400 contacts a second segment of the bottom surface of the support semiconductor substrate 510. In one embodiment, a bottom surface of the EIC die 600 contacts a first segment of a top surface of the PIC die 700; a bottom surface of the embedded optical connector die 400 contacts a second segment of the top surface of the PIC die 700; and the EIC die 600 is laterally surrounded by a dielectric matrix that contacts a sidewall of the EIC die 600.

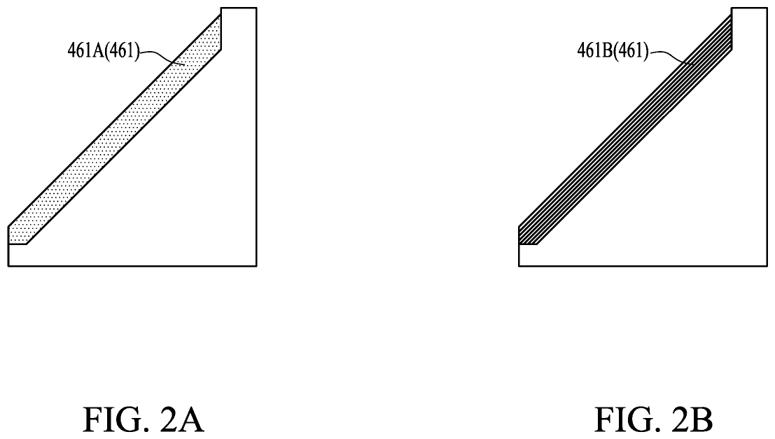

FIG. 2A is a vertical cross-sectional view of a first embodiment of a reflector mirror in an optical connector die 400 according to an aspect of the present disclosure. FIG. 2B is a vertical cross-sectional view of a second embodiment of a reflector mirror in an optical connector die 400 according to an aspect of the present disclosure.

Referring to FIG. 2A, a first configuration for the in-die mirror 461 is illustrated. In one embodiment, the in-die mirror 461 may comprise a metal-coated mirror 461A including a coating of a metal such as a layer stack of Cu/Al/Ta, an Al—Cu compound, an Al—Cu—Si compound, etc.

Referring to FIG. 2B, a second configuration for the in-die mirror 461 is illustrated. In one embodiment, the in-die mirror 461 may comprise a superlattice 461B of dielectric material layers in which a repetition unit including at least two dielectric material layers is repeated with a periodicity to maximize the reflectivity at the wavelength of the optical beam. The total number of repetitions of the repetition unit may be in a range from 2 to 20, although a greater number may also be used.

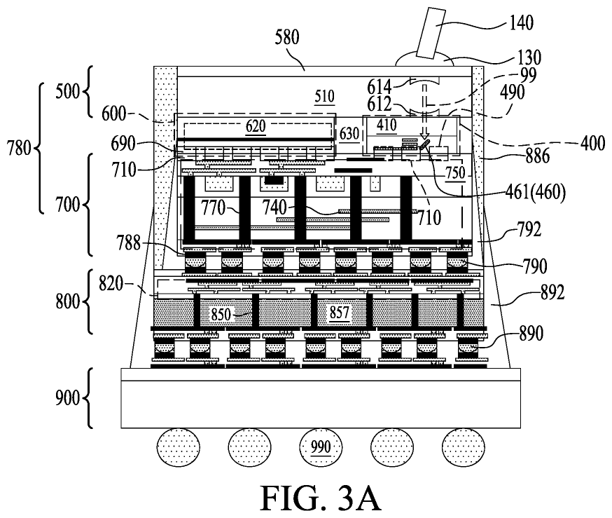

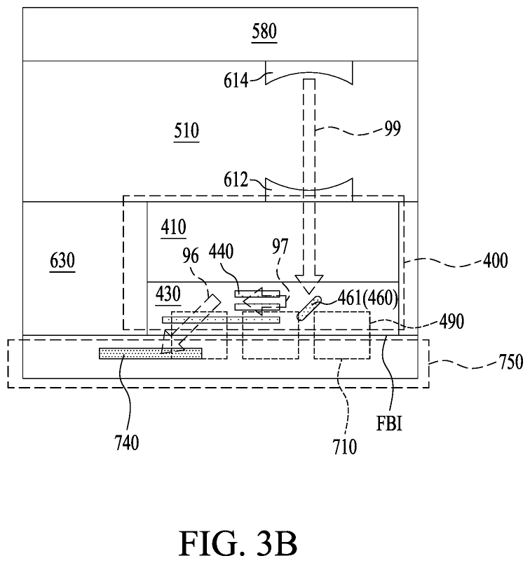

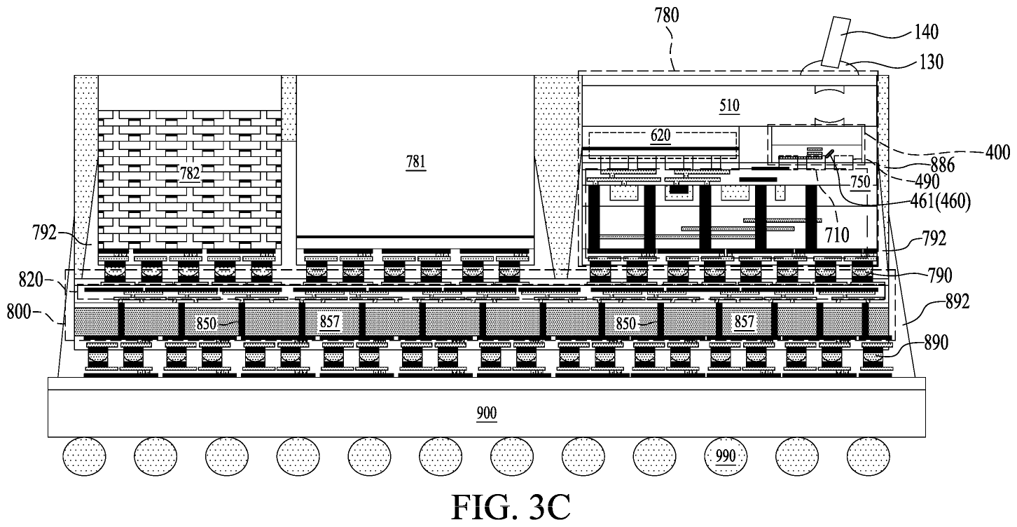

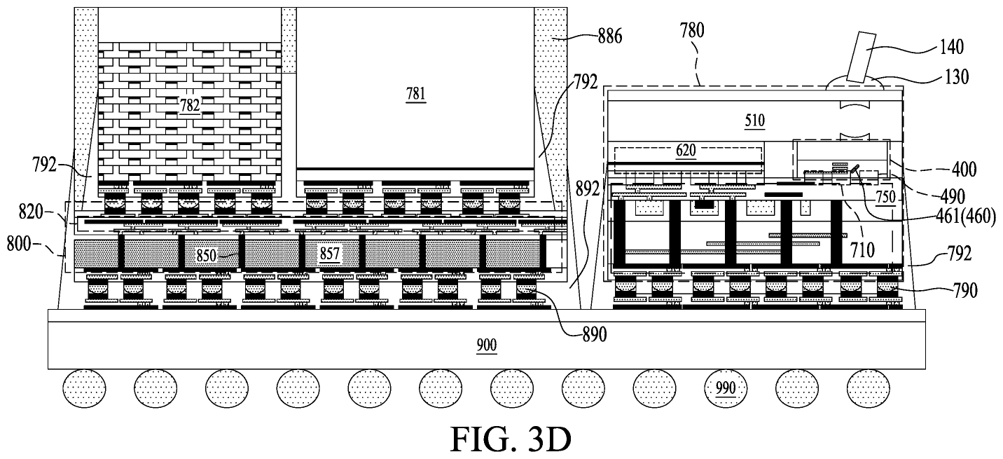

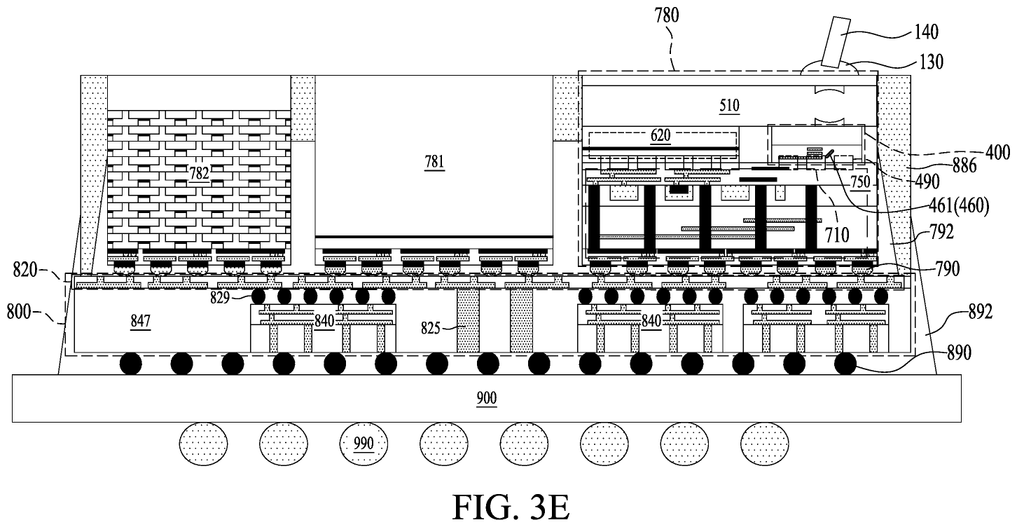

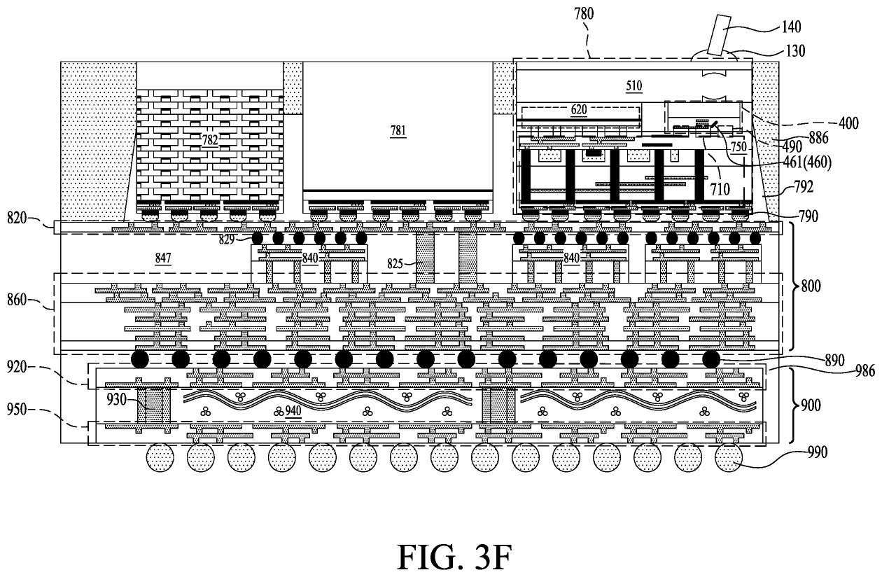

FIG. 3A is a vertical cross-sectional view of a second embodiment structure of the present disclosure according to an aspect of the present disclosure. FIG. 3B is a magnified view of a portion of the first embodiment structure of FIG. 3A. FIGS. 3C-3F are vertical cross-sectional views of various alternative configurations of the second embodiment structure.

Referring to FIGS. 3A and 3B, the second embodiment structure may be derived from the first embodiment structure illustrated in FIGS. 1A and 1B by modifying the optical connector die 400 that is embedded in the dielectric matrix 630. Specifically, the optical connector die 400 comprises metallic bonding pads, which are herein referred to as connector-die metallic bonding pads 490 and/or first metallic bonding pads 490. The connector-die metallic bonding pads 490 are embedded within the dielectric material layers 430 of the optical connector die 400. The connector-die metallic bonding pads 490 comprises a metal such as copper that may form metal-to-metal bonding. The pattern of the connector-die metallic bonding pads 490 may be a mirror image of a subset of the PIC metallic bonding pads 710. In one embodiment, the connector-die metallic bonding pads 490 and the PIC metallic bonding pads 710 may comprise, and/or may consist essentially of, a metallic barrier liner including a metallic barrier material (such as TiN, TaN, WN, MON, etc.) and a metallic bonding material such as copper. The connector-die metallic bonding pads 490 may be referred to as first metallic bonding pads, and the PIC metallic bonding pads 710 may be referred to as second metallic bonding pads in the claims.

Generally, the connector-die metallic bonding pads 490 may be arranged around the optical deflector 460 and the waveguides 440 in a manner that does not interfere with the functionality of the optical deflector 460 and the waveguides 440. Further, the PIC metallic bonding pads 710 may be arranged around the waveguides 740 in the PIC die 700 so that the PIC metallic bonding pads 710 do not interfere with the functionality of the waveguides 740 in the PIC die 700. The optical connector die 400 may be bonded to the PIC die 700 by metal-to-metal bonding between the connector-die metallic bonding pads 490 and the PIC metallic bonding pads 710. Optical signals may be transmitted through the waveguides 440 in the optical connector die 400 and the waveguides 740 in the PIC die 700 through evanescent coupling.

Further, a dielectric material layer within the PIC die 700 may be bonded to the dielectric material layers 430 in the optical connector die 400 by dielectric-to-dielectric bonding, such as silicon oxide-to-silicon oxide bonding. In this embodiment, a hybrid bonding interface (HBI) at which metal-to-metal bonding and dielectric-to-dielectric bonding are present may be formed between the PIC die 700 and the optical connector die 400. Subsequently, the dielectric matrix 630 may be formed around the EIC die 600 and the optical connector die 400, and the optical connector die 400 becomes the embedded optical connector die 400. Subsequently, the support semiconductor substrate 510 may be formed over the assembly of the EIC die 600, the optical connector die 400, and the dielectric matrix 630.

FIGS. 3C-3F are vertical cross-sectional views of various alternative configurations of the second embodiment structure.

Referring to FIG. 3C, a first alternative configuration of the second embodiment structure may be derived from the first alternative configuration of the first embodiment structure illustrated in FIG. 1C by using an embedded optical connector die 400 described with reference to FIGS. 3A and 3B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 3D, a second alternative configuration of the second embodiment structure may be derived from the second alternative configuration of the first embodiment structure illustrated in FIG. 1D by using an embedded optical connector die 400 described with reference to FIGS. 3A and 3B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 3E, a third alternative configuration of the second embodiment structure may be derived from the third alternative configuration of the first embodiment structure illustrated in FIG. 1E by using an embedded optical connector die 400 described with reference to FIGS. 3A and 3B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 3F, a fourth alternative configuration of the second embodiment structure may be derived from the fourth alternative configuration of the first embodiment structure illustrated in FIG. 1F by using an embedded optical connector die 400 described with reference to FIGS. 3A and 3B in lieu of an embedded optical connector die 400 described with reference to FIGS. 1A and 1B. The embedded optical connector die 400 may be bonded to the PIC die 700 through hybrid bonding to form a hybrid bonding interface.

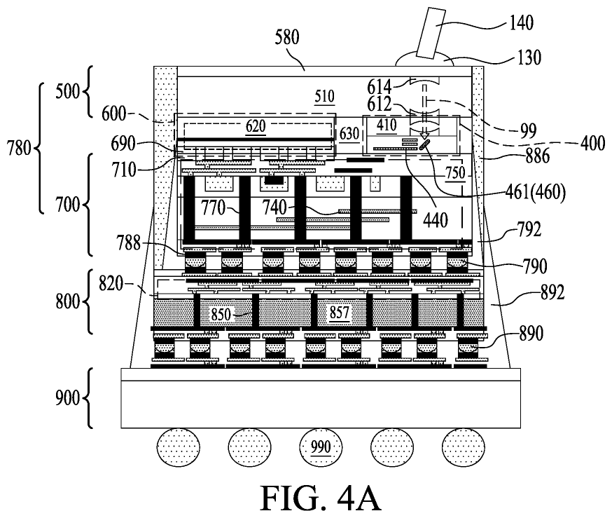

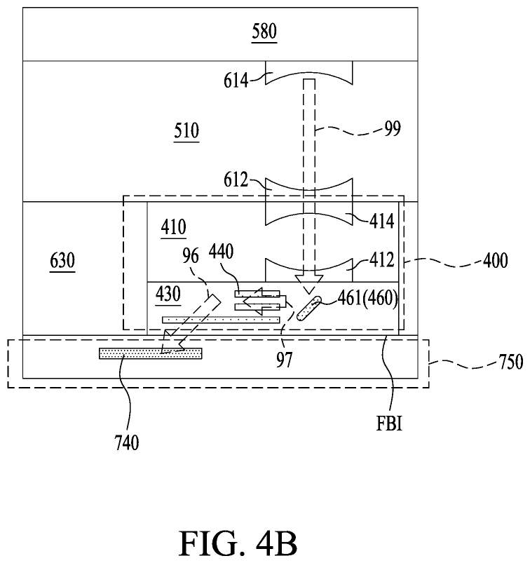

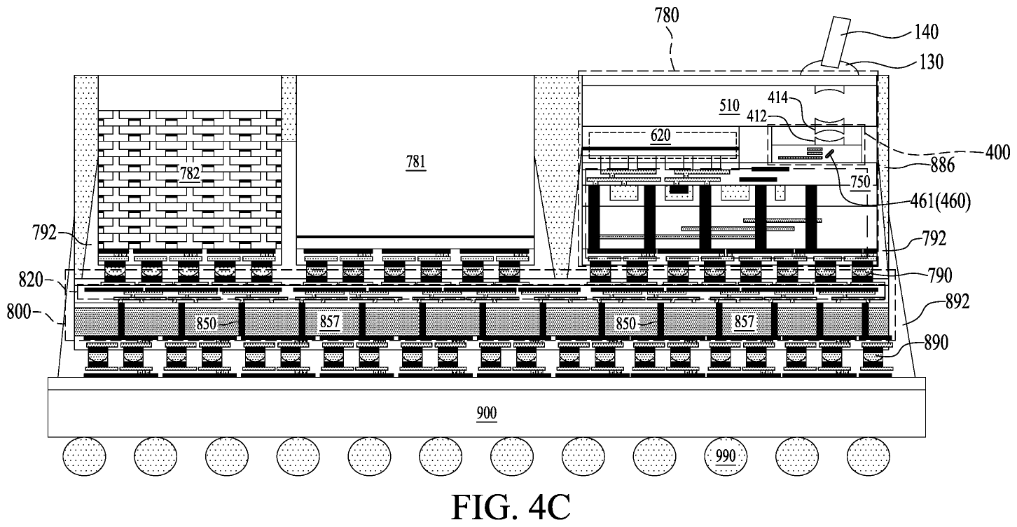

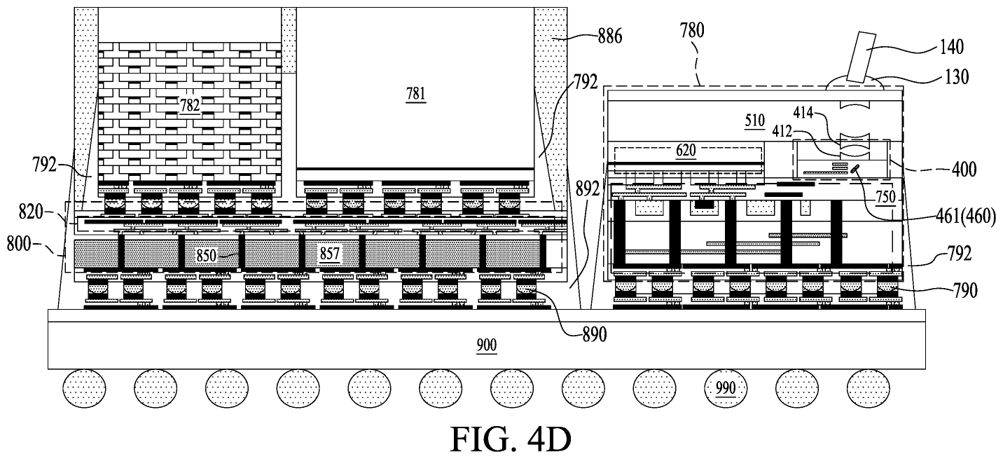

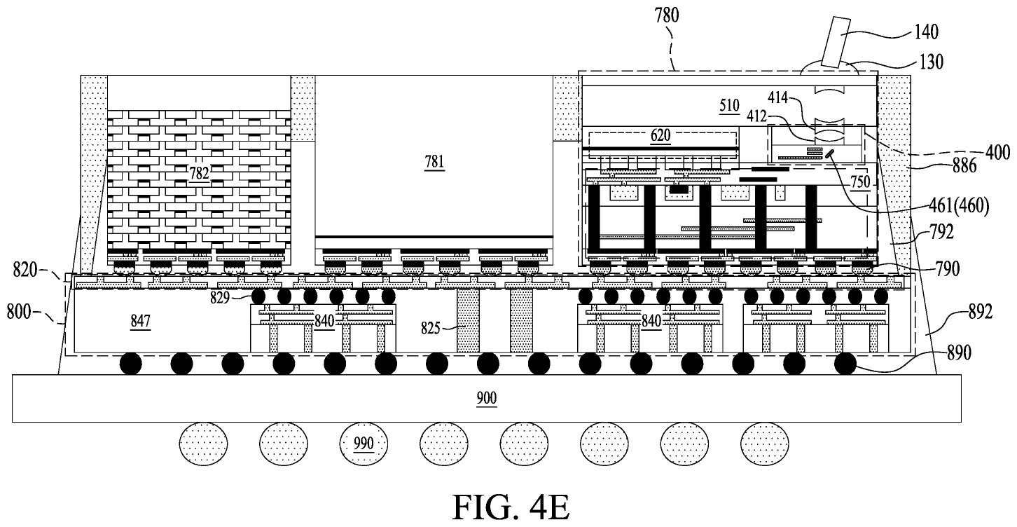

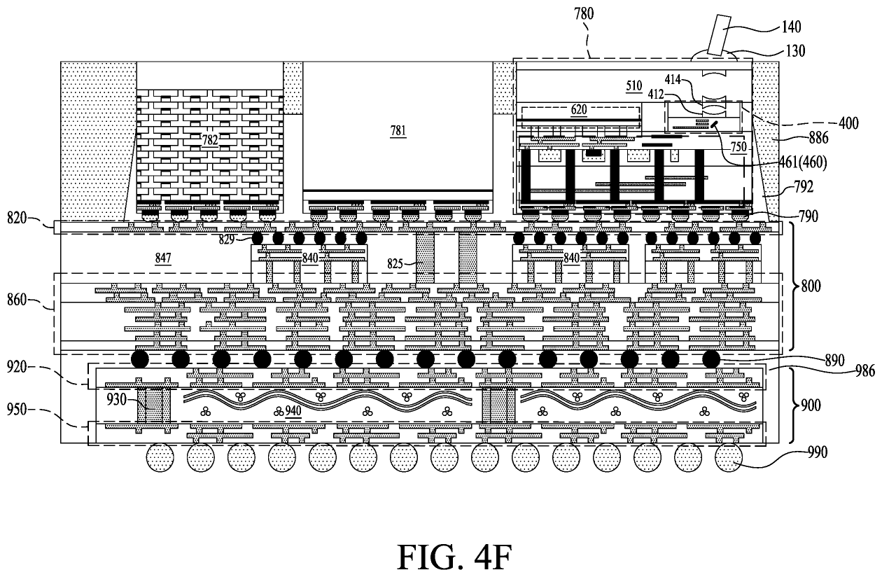

FIG. 4A is a vertical cross-sectional view of a third embodiment structure of the present disclosure according to an aspect of the present disclosure. FIG. 4B is a magnified view of a portion of the first embodiment structure of FIG. 4A. FIGS. 4C-4F are vertical cross-sectional views of various alternative configurations of the third embodiment structure.

Referring to FIGS. 4A and 4B, the third embodiment structure of the present disclosure may be derived from the first embodiment structure illustrated in FIGS. 1A and 1B by forming at least one optical lens (412, 414) within the embedded optical connector die 400 such that the at least one optical lens (412, 414) is located in a vertically-extending beam path 99 in the composite die 780. The at least one optical lens (412, 414) may be formed in the die substrate 410, for example, by forming a first contoured cavity having a first convex end surface on a first side (such as a proximal side that contact the dielectric material layers 430 of the optical connector die 400) of the die substrate 410, by forming a second contoured cavity having a second convex end surface on a second side (such as a distal side that contact the support semiconductor substrate 510) of the die substrate 410, and by filing the first contoured cavity and the second contoured cavity with a dielectric material such as silicon oxide or a transparent polymer material. A first in-die optical lens 412 (which is also referred to as a proximal in-die optical lens) may be formed in the first contoured cavity, and a second in-die optical lens 414 (which is also referred to as a distal in-die optical lens) may be formed in the second contoured cavity. Generally, the embedded optical connector die 400 comprises optical elements located within, or at an end of, the vertically-extending beam path 99. In the third embodiment structure, the optical elements comprise at least one optical lens (412, 414) configured to focus a light beam within the vertically-extending beam path 99, and an optical deflector 460, which may comprise an in-die mirror 461. A fusion bonding interface (FBI) may be formed between the embedded optical connector die 400 and the PIC die 700.

FIGS. 4C-4F are vertical cross-sectional views of various alternative configurations of the third embodiment structure.

Referring to FIG. 4C, a first alternative configuration of the third embodiment structure may be derived from the first alternative configuration of the first embodiment structure illustrated in FIG. 1C by using an embedded optical connector die 400 described with reference to FIGS. 4A and 4B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 4D, a second alternative configuration of the third embodiment structure may be derived from the second alternative configuration of the first embodiment structure illustrated in FIG. 1D by using an embedded optical connector die 400 described with reference to FIGS. 4A and 4B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 4E, a third alternative configuration of the third embodiment structure may be derived from the third alternative configuration of the first embodiment structure illustrated in FIG. 1E by using an embedded optical connector die 400 described with reference to FIGS. 4A and 4B in lieu of an embedded optical connector die 400 described with reference to FIGS. 1A and 1B. The embedded optical connector die 400 may be bonded to the PIC die 700 through hybrid bonding to form a hybrid bonding interface.

Referring to FIG. 4F, a fourth alternative configuration of the third embodiment structure may be derived from the fourth alternative configuration of the first embodiment structure illustrated in FIG. 1F by using an embedded optical connector die 400 described with reference to FIGS. 4A and 4B in lieu of an embedded optical connector die 400 described with reference to FIGS. 1A and 1B. The embedded optical connector die 400 may be bonded to the PIC die 700 through hybrid bonding to form a hybrid bonding interface.

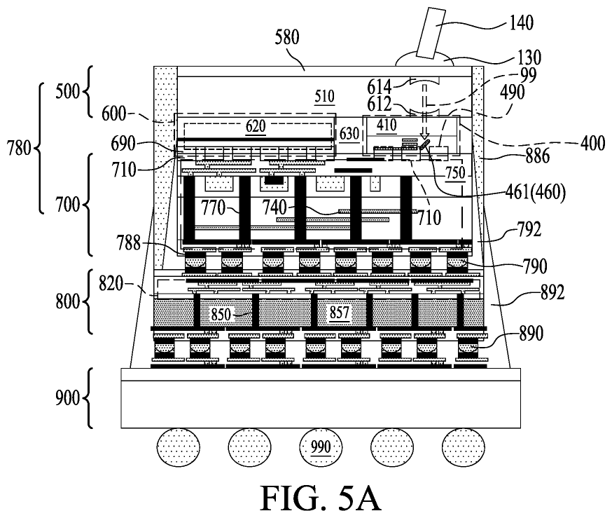

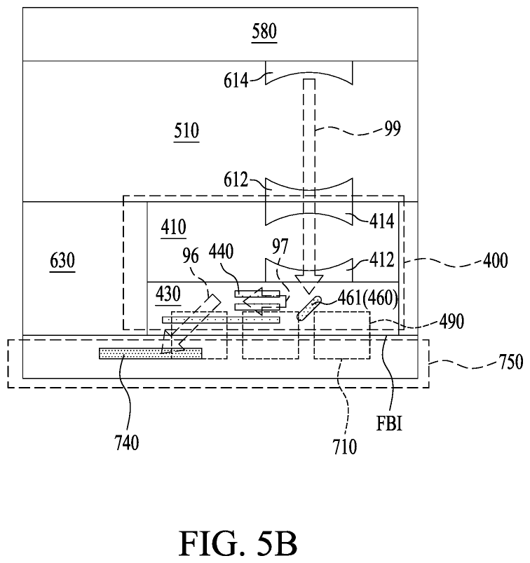

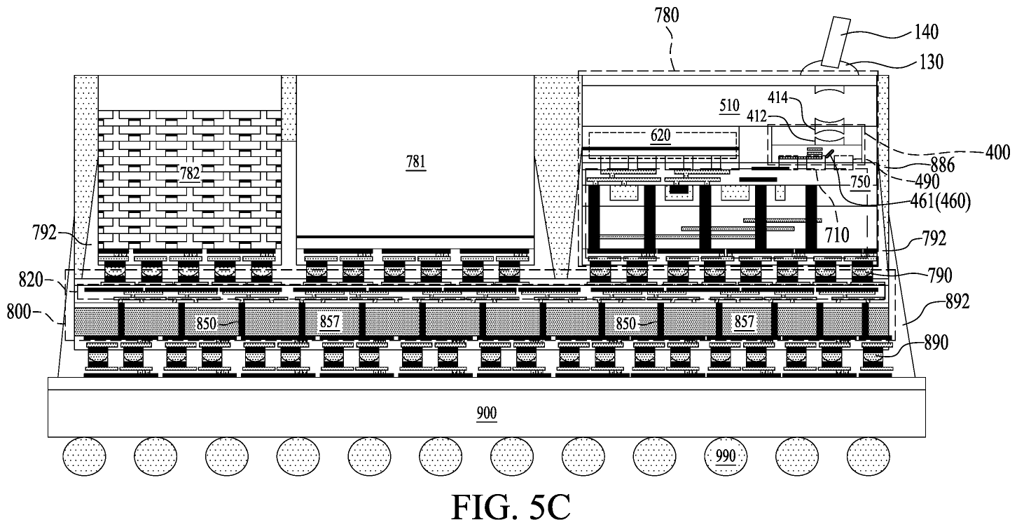

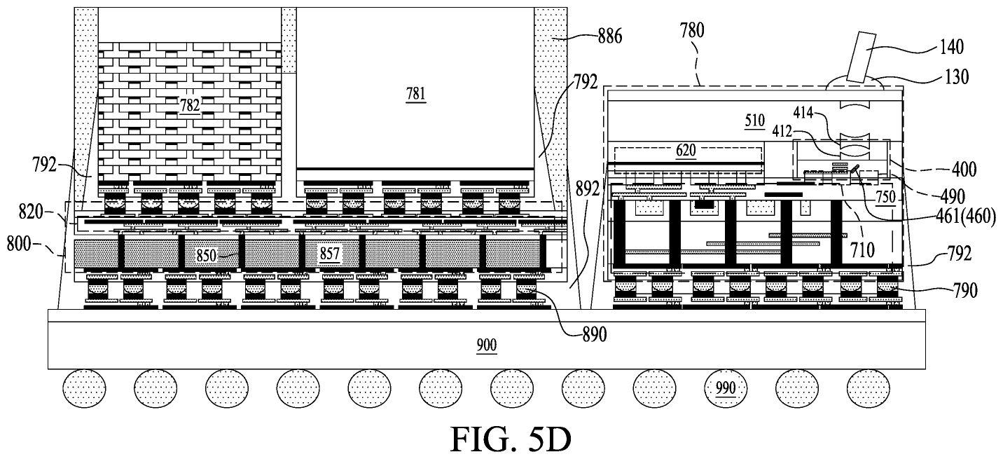

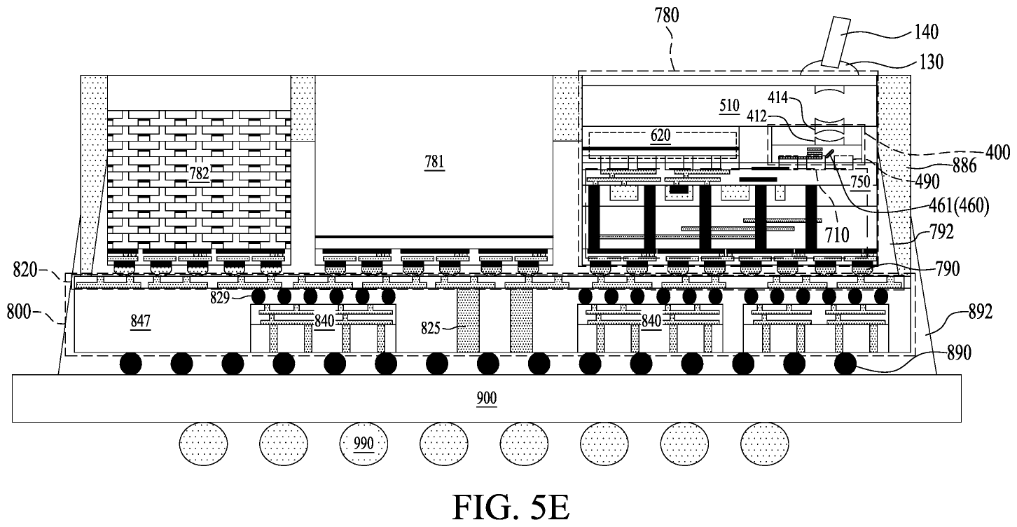

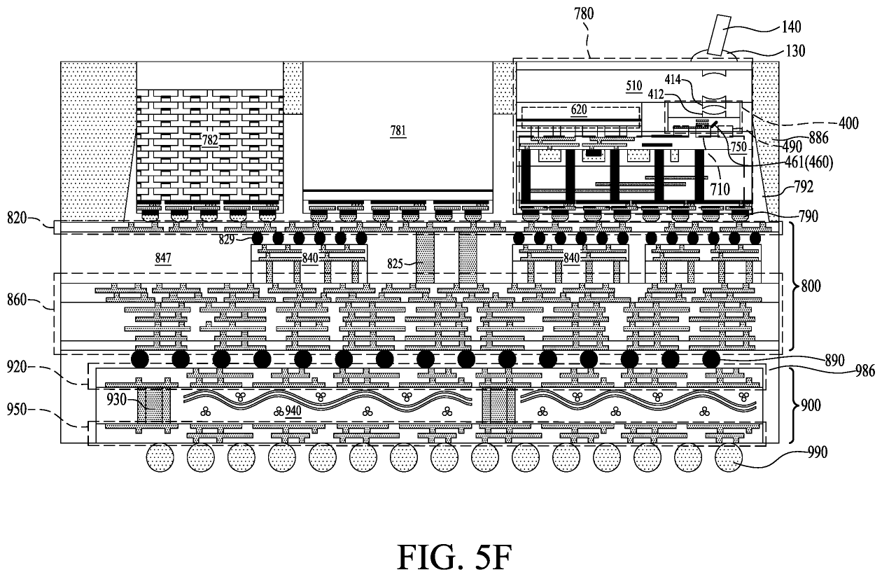

FIG. 5A is a vertical cross-sectional view of a fourth embodiment structure of the present disclosure according to an aspect of the present disclosure. FIG. 5B is a magnified view of a portion of the first embodiment structure of FIG. 5A. FIGS. 5C-5F are vertical cross-sectional views of various alternative configurations of the fourth embodiment structure.

Referring to FIGS. 5A and 5B, the fourth embodiment structure may be derived from the third embodiment structure illustrated in FIGS. 4A and 4B by modifying the optical connector die 400 that is embedded in the dielectric matrix 630 to include connector-die metallic bonding pads 490. The connector-die metallic bonding pads 490 are embedded within the dielectric material layers 430 of the optical connector die 400. The connector-die metallic bonding pads 490 comprises a metal such as copper that may form metal-to-metal bonding. The pattern of the connector-die metallic bonding pads 490 may be a mirror image of a subset of the PIC metallic bonding pads 710. Generally, the connector-die metallic bonding pads 490 and the PIC metallic bonding pads 710 may have the same configuration as in the second embodiment structure described with reference to FIGS. 3A and 3B.

The optical connector die 400 may be bonded to the PIC die 700 by metal-to-metal bonding between the connector-die metallic bonding pads 490 and the PIC metallic bonding pads 710. Optical signals may be transmitted through the waveguides 440 in the optical connector die 400 and the waveguides 740 in the PIC die 700 through evanescent coupling. Further, a dielectric material layer within the PIC die 700 may be bonded to the dielectric material layers 430 in the optical connector die 400 by dielectric-to-dielectric bonding, such as silicon oxide-to-silicon oxide bonding. In this embodiment, a hybrid bonding interface (HBI) at which metal-to-metal bonding and dielectric-to-dielectric bonding are present may be formed between the PIC die 700 and the optical connector die 400. Subsequently, the dielectric matrix 630 may be formed around the EIC die 600 and the optical connector die 400, and the optical connector die 400 becomes the embedded optical connector die 400. Subsequently, the support semiconductor substrate 510 may be formed over the assembly of the EIC die 600, the optical connector die 400, and the dielectric matrix 630.

FIGS. 5C-5F are vertical cross-sectional views of various alternative configurations of the fourth embodiment structure.

Referring to FIG. 5C, a first alternative configuration of the fourth embodiment structure may be derived from the first alternative configuration of the third embodiment structure illustrated in FIG. 1C by using an embedded optical connector die 400 described with reference to FIGS. 5A and 5B in lieu of an embedded optical connector die 400 described with reference to FIGS. 4A and 4B. The embedded optical connector die 400 may be bonded to the PIC die 700 through hybrid bonding to form a hybrid bonding interface.

Referring to FIG. 5D, a second alternative configuration of the fourth embodiment structure may be derived from the second alternative configuration of the third embodiment structure illustrated in FIG. 1D by using an embedded optical connector die 400 described with reference to FIGS. 5A and 5B in lieu of an embedded optical connector die 400 described with reference to FIGS. 4A and 4B. The embedded optical connector die 400 may be bonded to the PIC die 700 through hybrid bonding to form a hybrid bonding interface.

Referring to FIG. 5E, a third alternative configuration of the fourth embodiment structure may be derived from the third alternative configuration of the third embodiment structure illustrated in FIG. 1E by using an embedded optical connector die 400 described with reference to FIGS. 5A and 5B in lieu of an embedded optical connector die 400 described with reference to FIGS. 4A and 4B. The embedded optical connector die 400 may be bonded to the PIC die 700 through hybrid bonding to form a hybrid bonding interface.

Referring to FIG. 5F, a fourth alternative configuration of the fourth embodiment structure may be derived from the fourth alternative configuration of the third embodiment structure illustrated in FIG. 1F by using an embedded optical connector die 400 described with reference to FIGS. 5A and 5B in lieu of an embedded optical connector die 400 described with reference to FIGS. 4A and 4B. The embedded optical connector die 400 may be bonded to the PIC die 700 through hybrid bonding to form a hybrid bonding interface.

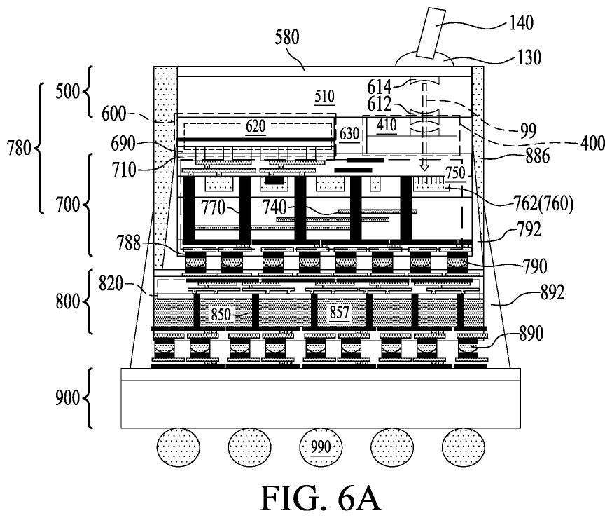

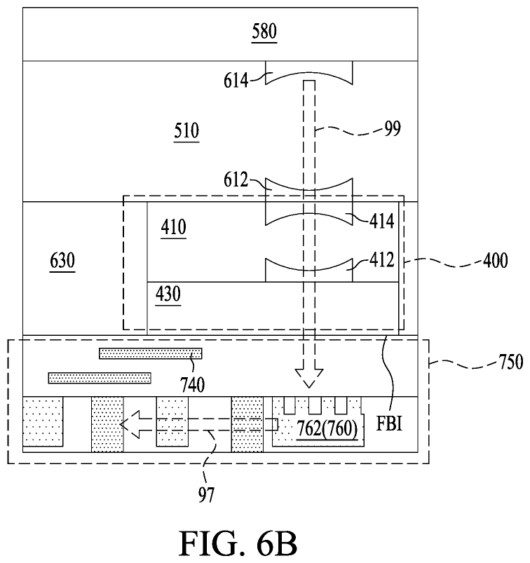

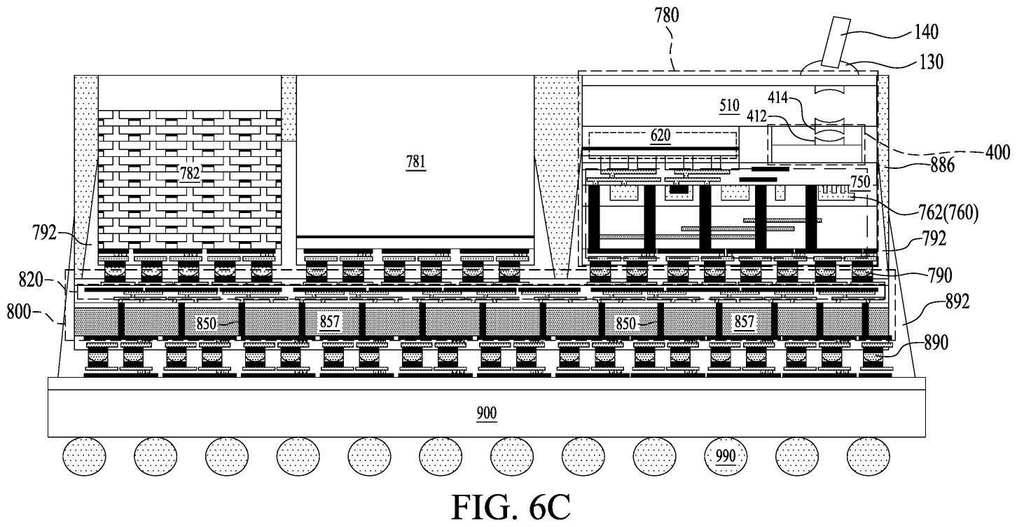

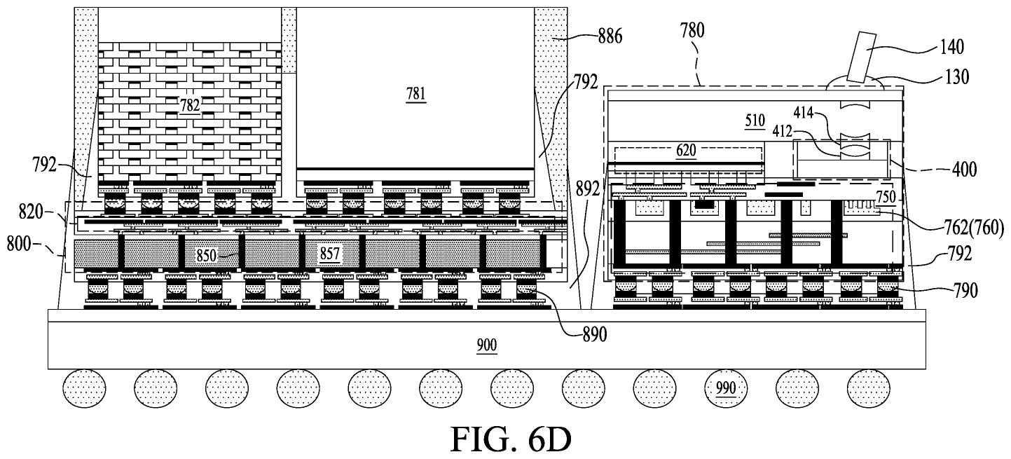

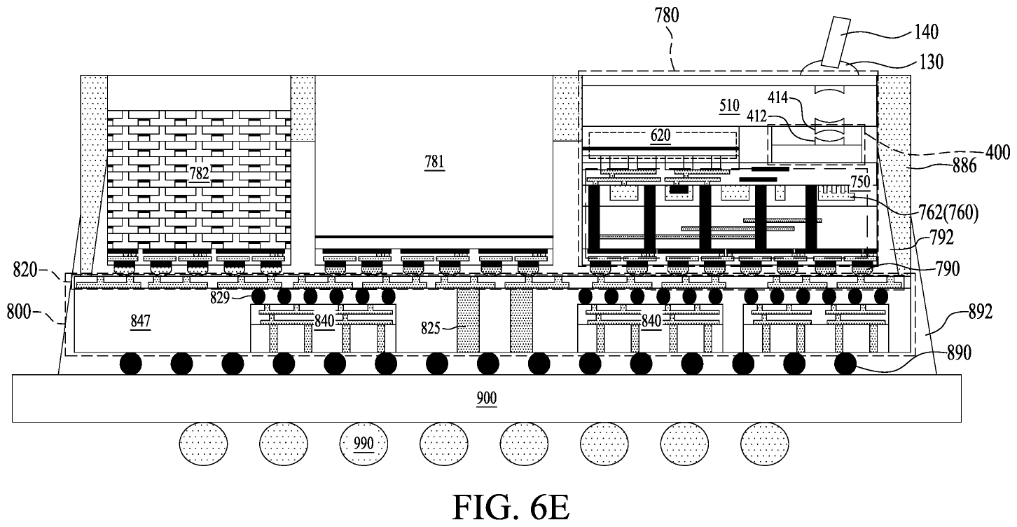

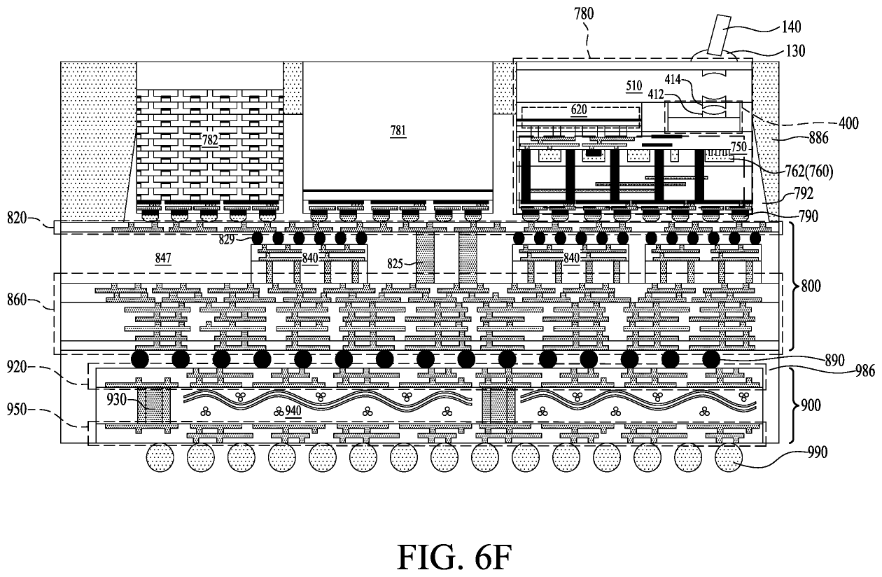

FIG. 6A is a vertical cross-sectional view of a fifth embodiment structure of the present disclosure according to an aspect of the present disclosure. FIG. 6B is a magnified view of a portion of the first embodiment structure of FIG. 6A. FIGS. 6C-6F are vertical cross-sectional views of various alternative configurations of the fifth embodiment structure.

Referring to FIGS. 6A and 6B, the fifth embodiment structure of the present disclosure may be derived from the third embodiment structure illustrated in FIGS. 4A and 4B by forming an optical deflector 760 within the PIC die 700. The optical deflector 760 may comprise a grating coupler 762 that may be an end portion of, or is optically coupled to, one of the waveguides 740 in the PIC die 700. In an alternative embodiment, the grating coupler 762 may be replaced with an in-die mirror having a same configuration as the in-die mirror 461 described above, but is embedded within dielectric material layers of the PIC die 700.

The grating coupler 762 comprises an optical grating having a periodicity along a horizontal direction. Generally, the grating coupler 762 may be used to efficiently couple light between a waveguide 740 in the PIC die 700 and a vertically-propagating beam that propagates through an upper portion of the PIC die 700. The grating coupler 762 may comprise a periodic pattern of alternating transparent and opaque sections. The periodicity of the periodic pattern is selected to maximize optical coupling at the wavelength of the light to be used for photonic signal transmission. When light encounters the grating of the grating coupler 762 from a vertical direction, the light undergoes scattering. The dimensions of the grating may be selected such that the light constructively interferes only along the direction of a waveguide 740. The same principle applies for the light exiting the waveguide 740 and impinging the grating coupler 762, and causes constructive interference only along the vertical direction, which is the exit direction of the light.

The optical connector die 400 comprises a die substrate 410 (which may comprise a semiconductor material such as silicon), and dielectric material layers 430 located on a horizontal surface of the die substrate 410. The optical connector die 400 comprises at least one optical element such as at least one optical lens (412, 414). In one embodiment, such that the at least one optical lens (412, 414) is located in a vertically-extending beam path 99 in the composite die 780. The at least one optical lens (412, 414) may be formed in the same manner as described with reference to FIGS. 4A and 4B. Generally, the embedded optical connector die 400 comprises optical elements located within, or at an end of, the vertically-extending beam path 99. In the fifth embodiment structure, the optical elements comprise at least one optical lens (412, 414) configured to focus a light beam within the vertically-extending beam path 99. A fusion bonding interface (FBI) may be formed between the embedded optical connector die 400 and the PIC die 700.

In the fifth embodiment structure, the PIC die 700 comprises an optical deflector 460 located at an end of the vertically-extending beam path 99 and is configured to change a beam direction between the vertically-extending beam path 99 and a horizontally-extending beam path 97 within a waveguide in the PIC die 700. The embedded optical connector die 400 comprises at least one optical lens (412, 414) located in a vertically-extending beam path 99 in the composite die 780.

FIGS. 6C-6F are vertical cross-sectional views of various alternative configurations of the fifth embodiment structure.

Referring to FIG. 6C, a first alternative configuration of the fifth embodiment structure may be derived from the first alternative configuration of the first embodiment structure illustrated in FIG. 1C by using a composite die 780 described with reference to FIGS. 6A and 6B in lieu of a composite die 780 described with reference to FIGS. 1A and 1B. The embedded optical connector die 400 may be bonded to the PIC die 700 through fusion bonding to form a fusion bonding interface.

Referring to FIG. 6D, a second alternative configuration of the fifth embodiment structure may be derived from the second alternative configuration of the first embodiment structure illustrated in FIG. 1D by using a composite die 780 described with reference to FIGS. 6A and 6B in lieu of a composite die 780 described with reference to FIGS. 1A and 1B. The embedded optical connector die 400 may be bonded to the PIC die 700 through fusion bonding to form a fusion bonding interface.

Referring to FIG. 6E, a third alternative configuration of the fifth embodiment structure may be derived from the third alternative configuration of the first embodiment structure illustrated in FIG. 1E by using a composite die 780 described with reference to FIGS. 6A and 6B in lieu of a composite die 780 described with reference to FIGS. 1A and 1B. The embedded optical connector die 400 may be bonded to the PIC die 700 through fusion bonding to form a fusion bonding interface.

Referring to FIG. 6F, a fourth alternative configuration of the fifth embodiment structure may be derived from the fourth alternative configuration of the first embodiment structure illustrated in FIG. 1F by using a composite die 780 described with reference to FIGS. 6A and 6B in lieu of a composite die 780 described with reference to FIGS. 1A and 1B. The embedded optical connector die 400 may be bonded to the PIC die 700 through fusion bonding to form a fusion bonding interface.

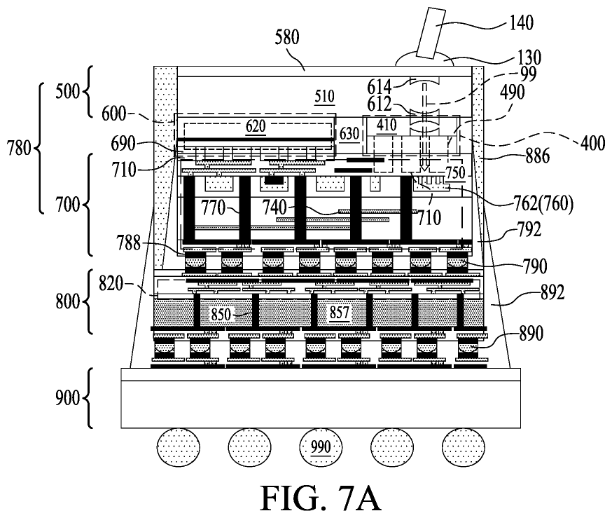

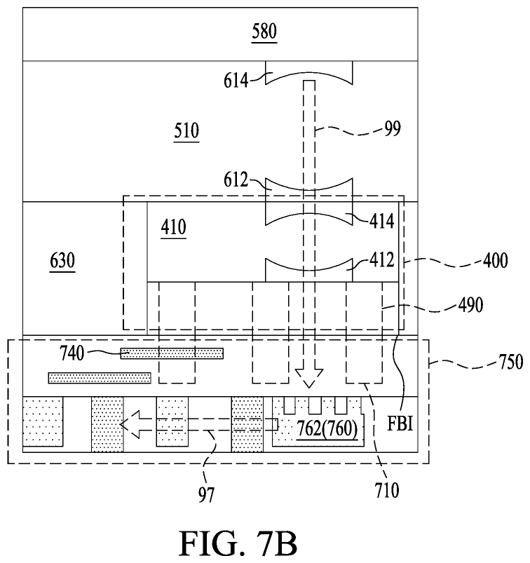

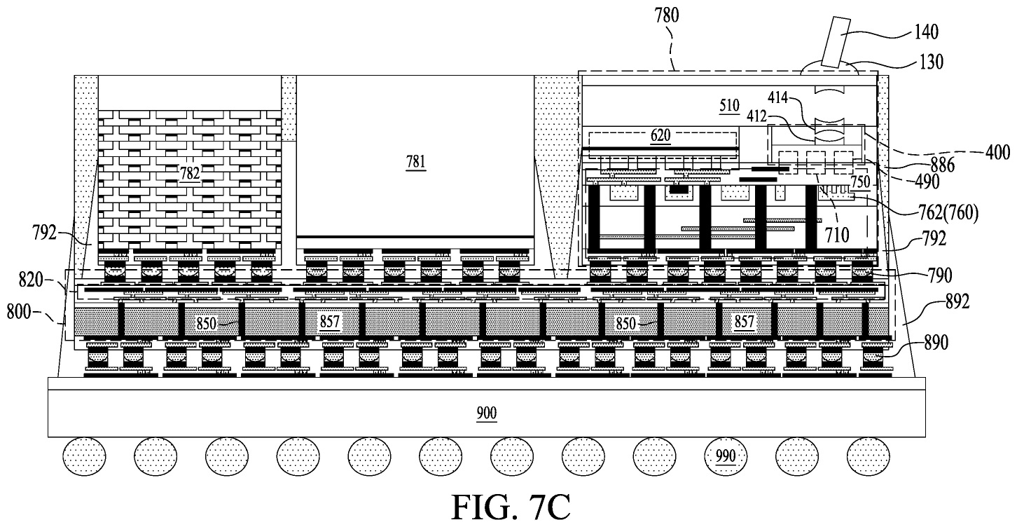

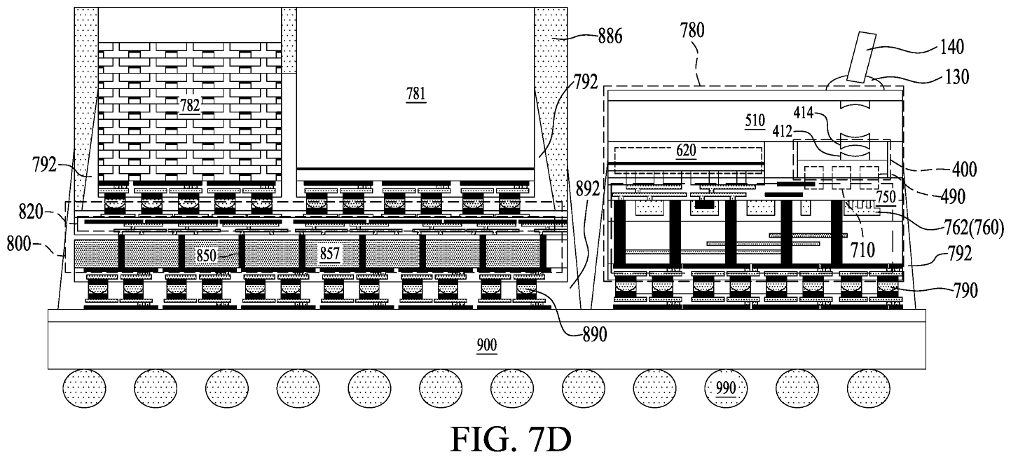

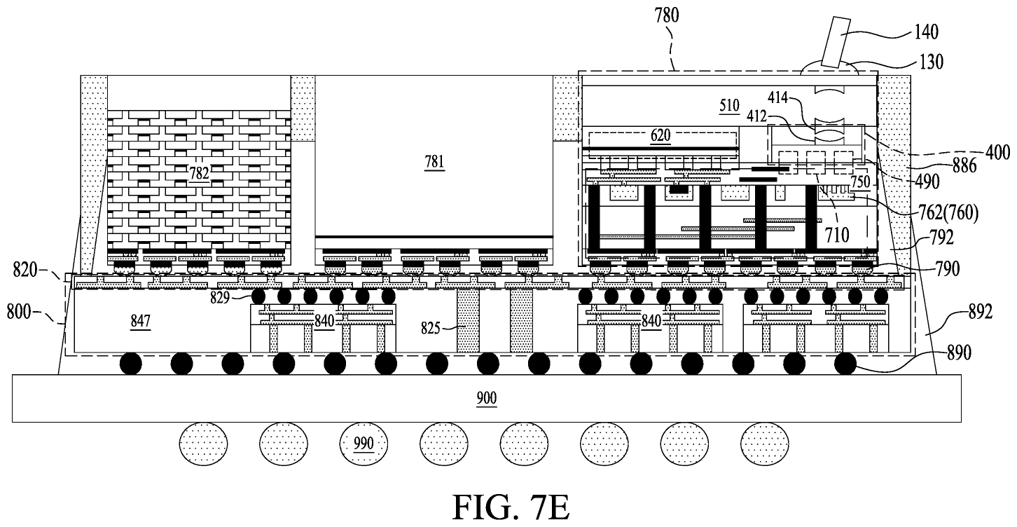

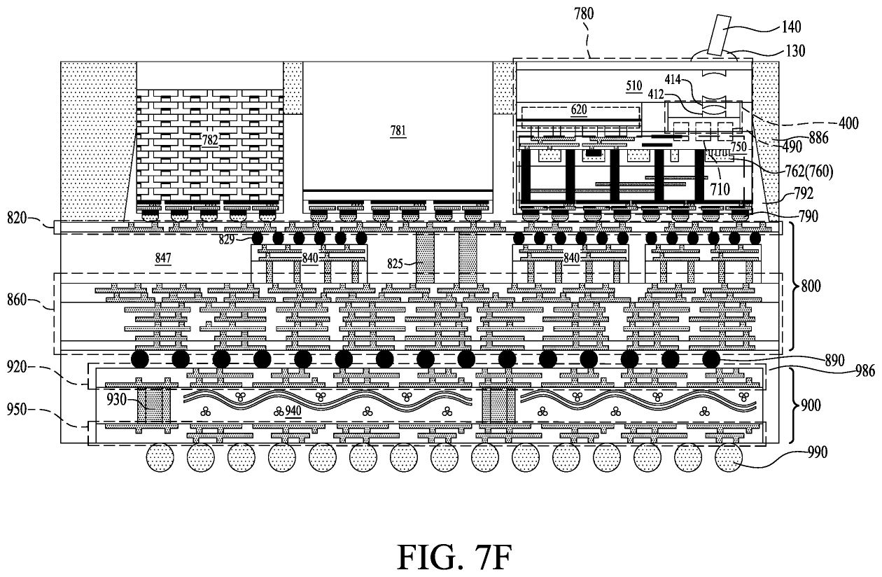

FIG. 7A is a vertical cross-sectional view of a sixth embodiment structure of the present disclosure according to an aspect of the present disclosure. FIG. 7B is a magnified view of a portion of the first embodiment structure of FIG. 7A. FIGS. 7C-7F are vertical cross-sectional views of various alternative configurations of the sixth embodiment structure.

Referring to FIGS. 7A and 7B, the sixth embodiment structure may be derived from the fifth embodiment structure illustrated in FIGS. 6A and 6B by modifying the optical connector die 400 that is embedded in the dielectric matrix 630 to include connector-die metallic bonding pads 490. The connector-die metallic bonding pads 490 are embedded within the dielectric material layers 430 of the optical connector die 400. The connector-die metallic bonding pads 490 comprises a metal such as copper that may form metal-to-metal bonding. The pattern of the connector-die metallic bonding pads 490 may be a mirror image of a subset of the PIC metallic bonding pads 710. Generally, the connector-die metallic bonding pads 490 and the PIC metallic bonding pads 710 may have the same configuration as in the second embodiment structure described with reference to FIGS. 3A and 3B.

The optical connector die 400 may be bonded to the PIC die 700 by metal-to-metal bonding between the connector-die metallic bonding pads 490 and the PIC metallic bonding pads 710. Further, a dielectric material layer within the PIC die 700 may be bonded to the dielectric material layers 430 in the optical connector die 400 by dielectric-to-dielectric bonding, such as silicon oxide-to-silicon oxide bonding. In this embodiment, a hybrid bonding interface (HBI) at which metal-to-metal bonding and dielectric-to-dielectric bonding are present may be formed between the PIC die 700 and the optical connector die 400. Subsequently, the dielectric matrix 630 may be formed around the EIC die 600 and the optical connector die 400, and the optical connector die 400 becomes the embedded optical connector die 400. Subsequently, the support semiconductor substrate 510 may be formed over the assembly of the EIC die 600, the optical connector die 400, and the dielectric matrix 630.

FIGS. 7C-7F are vertical cross-sectional views of various alternative configurations of the sixth embodiment structure.

Referring to FIG. 7C, a first alternative configuration of the sixth embodiment structure may be derived from the first alternative configuration of the fifth embodiment structure illustrated in FIG. 6C by using an embedded optical connector die 400 described with reference to FIGS. 7A and 7B in lieu of an embedded optical connector die 400 described with reference to FIGS. 6A and 6B. The embedded optical connector die 400 may be bonded to the PIC die 700 through hybrid bonding to form a hybrid bonding interface.

Referring to FIG. 7D, a second alternative configuration of the sixth embodiment structure may be derived from the second alternative configuration of the fifth embodiment structure illustrated in FIG. 6D by using an embedded optical connector die 400 described with reference to FIGS. 7A and 7B in lieu of an embedded optical connector die 400 described with reference to FIGS. 6A and 6B. The embedded optical connector die 400 may be bonded to the PIC die 700 through hybrid bonding to form a hybrid bonding interface.

Referring to FIG. 7E, a third alternative configuration of the sixth embodiment structure may be derived from the third alternative configuration of the fifth embodiment structure illustrated in FIG. 6E by using an embedded optical connector die 400 described with reference to FIGS. 7A and 7B in lieu of an embedded optical connector die 400 described with reference to FIGS. 6A and 6B. The embedded optical connector die 400 may be bonded to the PIC die 700 through hybrid bonding to form a hybrid bonding interface.

Referring to FIG. 7F, a fourth alternative configuration of the sixth embodiment structure may be derived from the fourth alternative configuration of the fifth embodiment structure illustrated in FIG. 6F by using an embedded optical connector die 400 described with reference to FIGS. 7A and 7B in lieu of an embedded optical connector die 400 described with reference to FIGS. 6A and 6B. The embedded optical connector die 400 may be bonded to the PIC die 700 through hybrid bonding to form a hybrid bonding interface.

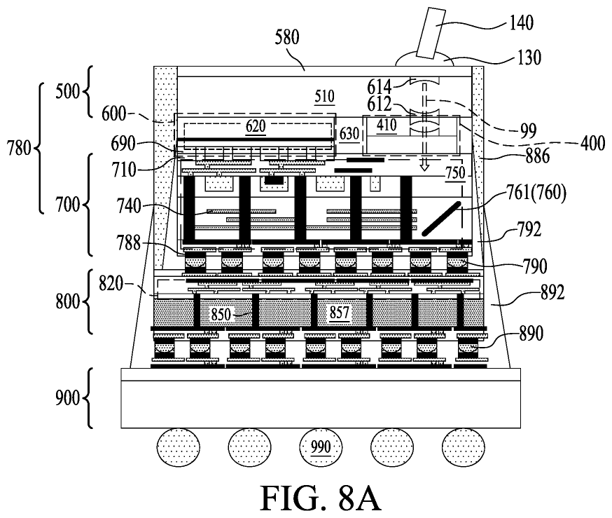

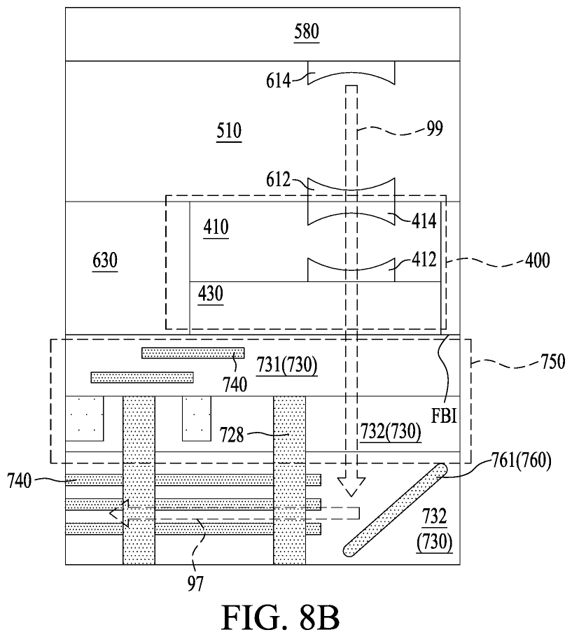

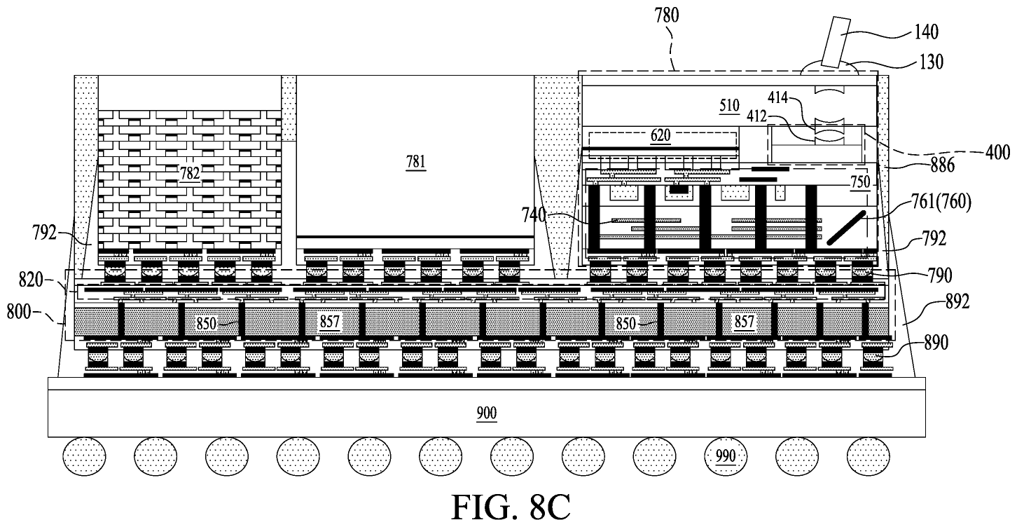

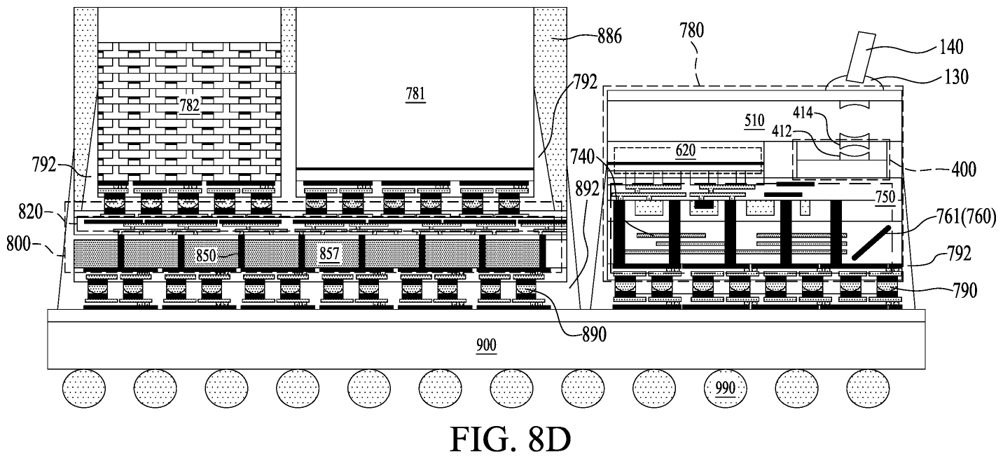

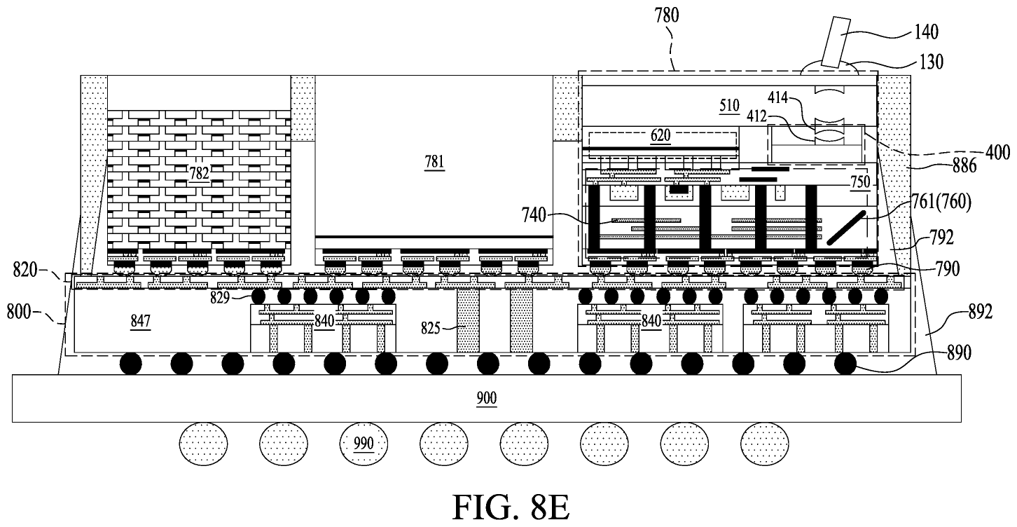

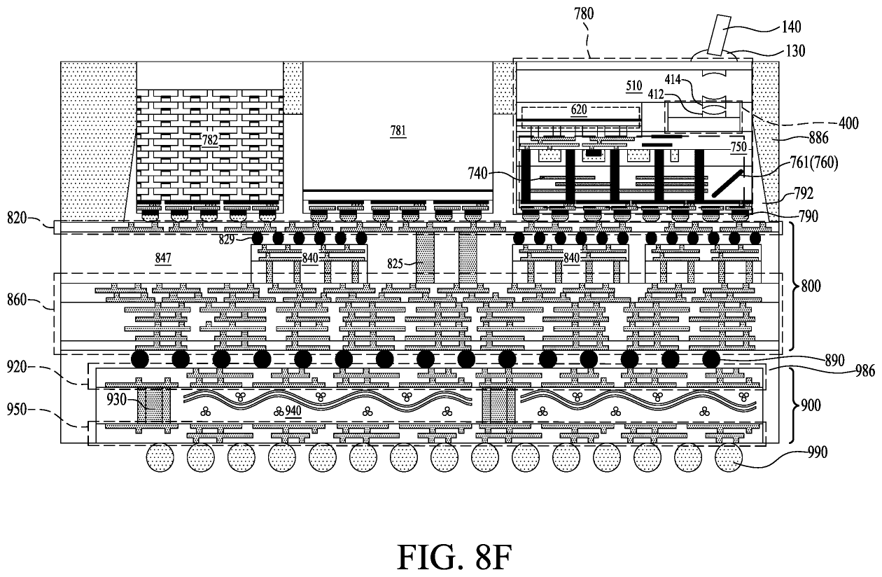

FIG. 8A is a vertical cross-sectional view of a seventh embodiment structure of the present disclosure according to an aspect of the present disclosure. FIG. 8B is a magnified view of a portion of the first embodiment structure of FIG. 8A. FIGS. 8C-8F are vertical cross-sectional views of various alternative configurations of the seventh embodiment structure.

Referring to FIGS. 8A and 8B, the seventh embodiment structure of the present disclosure may be derived from the fifth embodiment structure described with reference to FIGS. 7A and 7B by using a in-die mirror 761 as an optical deflector 760. The in-die mirror 761 may be embedded within dielectric material layers in the PIC die 700, and may be disposed adjacent to at least one waveguide 740 in the PIC die 700. The at least one waveguide 740 that is adjacent to the in-die mirror 761 may have a configuration of a transition edge coupler to enhance optical coupling between the at least one waveguide 740 and the in-die mirror 761. The in-die mirror 761 may have any configuration that may, or may not, be analogous to the configurations of the in-die mirrors 461 described with reference to FIGS. 2A and 2B.

FIGS. 8C-8F are vertical cross-sectional views of various alternative configurations of the seventh embodiment structure.

Referring to FIG. 8C, a first alternative configuration of the seventh embodiment structure may be derived from the first alternative configuration of the fifth embodiment structure illustrated in FIG. 7C by using a composite die 780 described with reference to FIGS. 8A and 8B in lieu of a composite die 780 described with reference to FIGS. 7A and 7B. The embedded optical connector die 400 may be bonded to the PIC die 700 through fusion bonding to form a fusion bonding interface.

Referring to FIG. 8D, a second alternative configuration of the seventh embodiment structure may be derived from the second alternative configuration of the fifth embodiment structure illustrated in FIG. 7D by using a composite die 780 described with reference to FIGS. 8A and 8B in lieu of a composite die 780 described with reference to FIGS. 7A and 7B. The embedded optical connector die 400 may be bonded to the PIC die 700 through fusion bonding to form a fusion bonding interface.

Referring to FIG. 8E, a third alternative configuration of the seventh embodiment structure may be derived from the third alternative configuration of the fifth embodiment structure illustrated in FIG. 7E by using a composite die 780 described with reference to FIGS. 8A and 8B in lieu of a composite die 780 described with reference to FIGS. 7A and 7B. The embedded optical connector die 400 may be bonded to the PIC die 700 through fusion bonding to form a fusion bonding interface.

Referring to FIG. 8F, a fourth alternative configuration of the seventh embodiment structure may be derived from the fourth alternative configuration of the fifth embodiment structure illustrated in FIG. 7F by using a composite die 780 described with reference to FIGS. 8A and 8B in lieu of a composite die 780 described with reference to FIGS. 7A and 7B. The embedded optical connector die 400 may be bonded to the PIC die 700 through fusion bonding to form a fusion bonding interface.

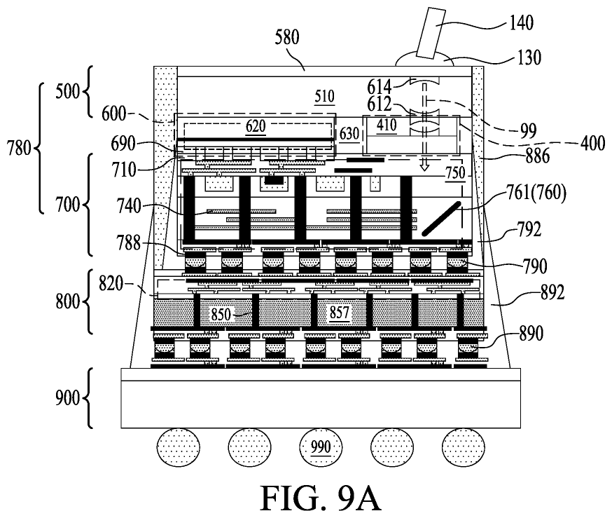

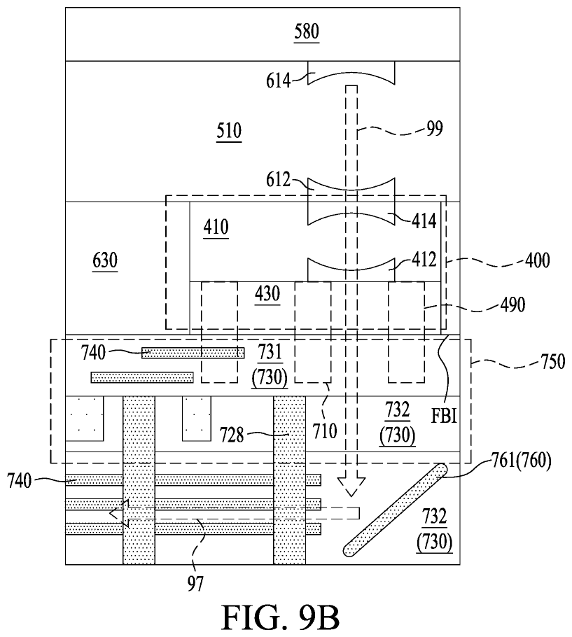

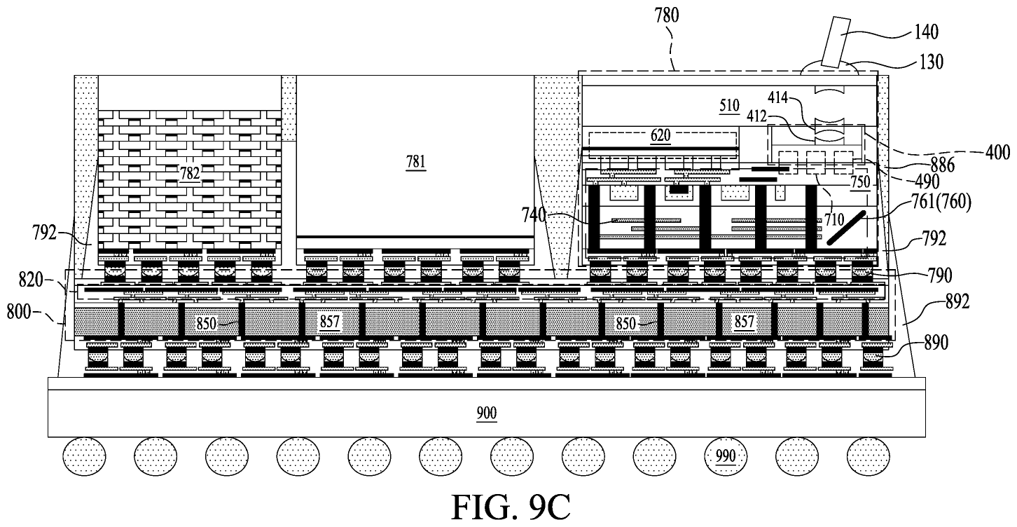

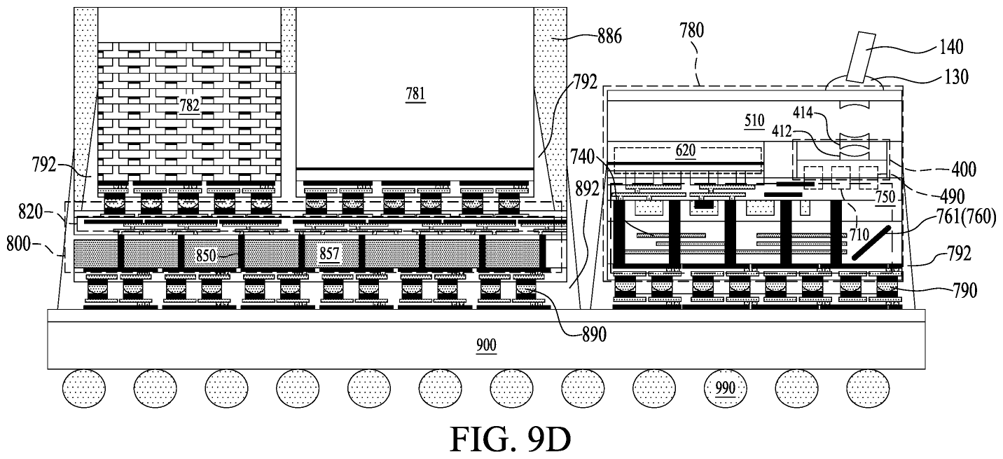

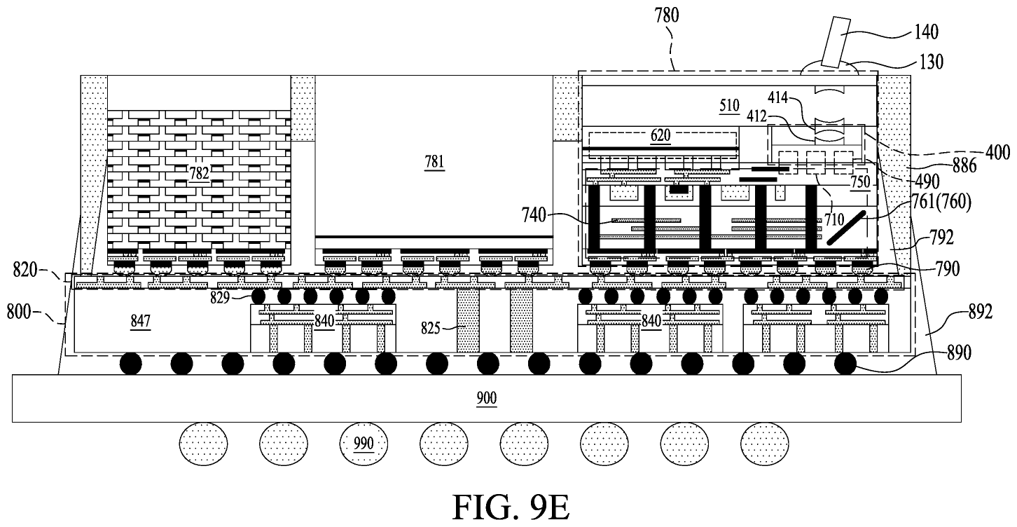

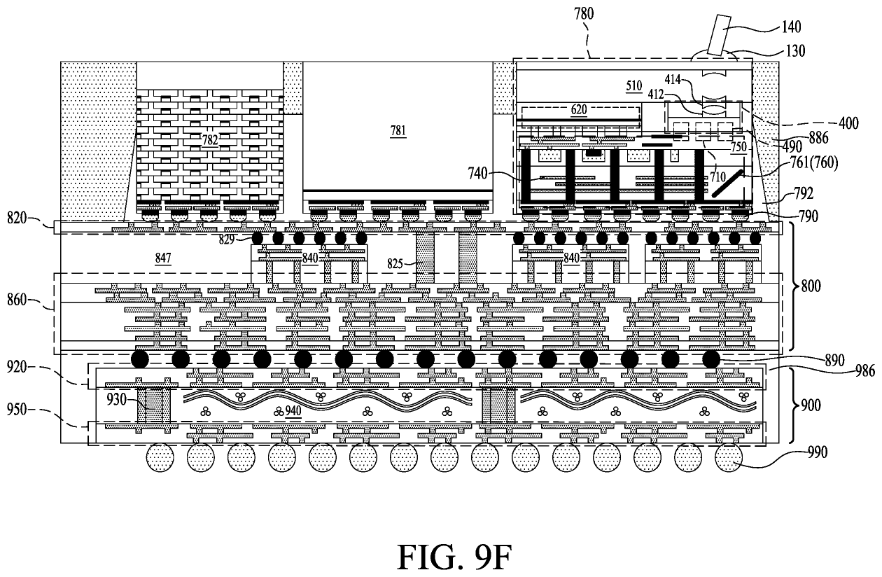

FIG. 9A is a vertical cross-sectional view of an eighth embodiment structure of the present disclosure according to an aspect of the present disclosure. FIG. 9B is a magnified view of a portion of the first embodiment structure of FIG. 9A. FIGS. 9C-9F are vertical cross-sectional views of various alternative configurations of the eighth embodiment structure.

Referring to FIGS. 9A and 9B, the eighth embodiment structure may be derived from the seventh embodiment structure illustrated in FIGS. 8A and 8B by modifying the optical connector die 400 that is embedded in the dielectric matrix 630 to include connector-die metallic bonding pads 490. The connector-die metallic bonding pads 490 are embedded within the dielectric material layers 430 of the optical connector die 400. The connector-die metallic bonding pads 490 comprises a metal such as copper that may form metal-to-metal bonding. The pattern of the connector-die metallic bonding pads 490 may be a mirror image of a subset of the PIC metallic bonding pads 710. Generally, the connector-die metallic bonding pads 490 and the PIC metallic bonding pads 710 may have the same configuration as in the second embodiment structure described with reference to FIGS. 3A and 3B.

The optical connector die 400 may be bonded to the PIC die 700 by metal-to-metal bonding between the connector-die metallic bonding pads 490 and the PIC metallic bonding pads 710. Further, a dielectric material layer within the PIC die 700 may be bonded to the dielectric material layers 430 in the optical connector die 400 by dielectric-to-dielectric bonding, such as silicon oxide-to-silicon oxide bonding. In this embodiment, a hybrid bonding interface (HBI) at which metal-to-metal bonding and dielectric-to-dielectric bonding are present may be formed between the PIC die 700 and the optical connector die 400. Subsequently, the dielectric matrix 630 may be formed around the EIC die 600 and the optical connector die 400, and the optical connector die 400 becomes the embedded optical connector die 400. Subsequently, the support semiconductor substrate 510 may be formed over the assembly of the EIC die 600, the optical connector die 400, and the dielectric matrix 630.

FIGS. 9C-9F are vertical cross-sectional views of various alternative configurations of the eighth embodiment structure.

Referring to FIG. 9C, a first alternative configuration of the eighth embodiment structure may be derived from the first alternative configuration of the seventh embodiment structure illustrated in FIG. 8C by using an embedded optical connector die 400 described with reference to FIGS. 9A and 9B in lieu of an embedded optical connector die 400 described with reference to FIGS. 8A and 8B. The embedded optical connector die 400 may be bonded to the PIC die 700 through hybrid bonding to form a hybrid bonding interface.

Referring to FIG. 9D, a second alternative configuration of the eighth embodiment structure may be derived from the second alternative configuration of the seventh embodiment structure illustrated in FIG. 8D by using an embedded optical connector die 400 described with reference to FIGS. 9A and 9B in lieu of an embedded optical connector die 400 described with reference to FIGS. 8A and 8B. The embedded optical connector die 400 may be bonded to the PIC die 700 through hybrid bonding to form a hybrid bonding interface.

Referring to FIG. 9E, a third alternative configuration of the eighth embodiment structure may be derived from the third alternative configuration of the seventh embodiment structure illustrated in FIG. 8E by using an embedded optical connector die 400 described with reference to FIGS. 9A and 9B in lieu of an embedded optical connector die 400 described with reference to FIGS. 8A and 8B. The embedded optical connector die 400 may be bonded to the PIC die 700 through hybrid bonding to form a hybrid bonding interface.

Referring to FIG. 9F, a fourth alternative configuration of the eighth embodiment structure may be derived from the fourth alternative configuration of the seventh embodiment structure illustrated in FIG. 8F by using an embedded optical connector die 400 described with reference to FIGS. 9A and 9B in lieu of an embedded optical connector die 400 described with reference to FIGS. 8A and 8B. The embedded optical connector die 400 may be bonded to the PIC die 700 through hybrid bonding to form a hybrid bonding interface.

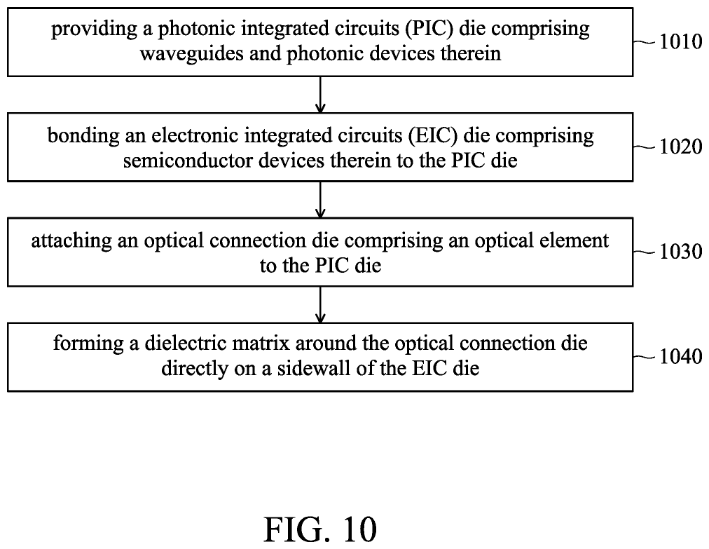

FIG. 10 is a flowchart illustrating general processing steps for forming a photonic assembly of the present disclosure.

Referring to step 1010 and FIGS. 1A-9F, a photonic integrated circuits (PIC) die 700 comprising waveguides 740 and photonic devices 750 therein may be provided.

Referring to step 1020 and FIGS. 1A-9F, an electronic integrated circuits (EIC) die 600 comprising semiconductor devices 620 therein may be bonded to the PIC die 700.

Referring to step 1030 and FIGS. 1A-9F, an optical connector die 400 comprising an optical element may be attached to the PIC die 700.

Referring to step 1030 and FIGS. 1A-9F, a dielectric matrix 630 may be formed around the embedded optical connector die 400 directly on a sidewall of the EIC die 600.

Referring to all drawings and according to various embodiments of the present disclosure, a photonic assembly comprising a composite die 780 is provided. The composite die 780 comprises: a photonic integrated circuits (PIC) die 700 comprising waveguides 740 and photonic devices 750 therein; an electronic integrated circuits (EIC) die 600 comprising semiconductor devices 620 therein; and an embedded optical connector die 400 contacting a top surface of the PIC die 700 and laterally spaced from the EIC die 600.

In one embodiment, the embedded optical connector die 400 comprises an optical deflector 460 that is configured to change a beam direction between a vertically-extending beam path 99 within the composite die 780 and a horizontally-extending beam path 97 within a first waveguide in the embedded optical connector die 400. In one embodiment, the vertically-extending beam path 99 is located entirely outside the PIC die 700.

In one embodiment, the embedded optical connector die 400 comprises at least one optical lens (412, 414) located in a vertically-extending beam path 99 in the composite die 780. In one embodiment, the PIC die 700 comprises an optical deflector 460 configured to change a beam direction between the vertically-extending beam path 99 and a horizontally-extending beam path 97 within a horizontally-extending waveguide in the PIC die 700.

In one embodiment, the photonic assembly comprises a dielectric matrix 630 laterally surrounding the embedded optical connector die 400 and contacting a sidewall of the EIC die 600. In one embodiment, the composite die 780 comprises a support semiconductor substrate 510 overlying the EIC die 600 and the embedded optical connector die 400. In one embodiment, the vertically-extending beam path 99 extends through the support semiconductor substrate 510. In one embodiment, the embedded optical connector die 400 contacts a bottom surface of the support semiconductor substrate 510.

According to an aspect of the present disclosure, a photonic assembly comprising a composite die 780 is provided. The composite die 780 comprises: a photonic integrated circuits (PIC) die 700 comprising waveguides 740 and photonic devices 750 therein; an electronic integrated circuits (EIC) die 600 comprising semiconductor devices 620 therein; a support semiconductor substrate 510 overlying the PIC die 700 and the EIC die 600, wherein the composite die 780 is configured to provide a vertically-extending beam path 99 that extends through the support semiconductor substrate 510; and an embedded optical connector die 400 comprising an optical element located within, or at an end of, the vertically-extending beam path 99.

In one embodiment, the optical element comprises an optical deflector 460 that is configured to change a beam direction between the vertically-extending beam path 99 within the composite die 780 and a horizontally-extending beam path 97 within a first waveguide in the embedded optical connector die 400. In one embodiment, the optical element comprises at least one optical lens (412, 414) configured to focus a light beam within the vertically-extending beam path 99. In one embodiment, the embedded optical connector die 400 comprises first metallic bonding pads 490 embedded within dielectric material layers 430 of the embedded optical connector die 400; and the PIC die 700 comprises second metallic bonding pads 710 that are bonded to the first metallic bonding pads 490 by metal-to-metal bonding.

In one embodiment, a top surface of the EIC die 600 contacts a first segment of a bottom surface of the support semiconductor substrate 510; and a top surface of the embedded optical connector die 400 contacts a second segment of the bottom surface of the support semiconductor substrate 510. In one embodiment, a bottom surface of the EIC die 600 contacts a first segment of a top surface of the PIC die 700; a bottom surface of the embedded optical connector die 400 contacts a second segment of the top surface of the PIC die 700; and the EIC die 600 is laterally surrounded by a dielectric matrix 630 that contacts a sidewall of the EIC die 600.

The various embodiments of the present disclosure may be used to provide photonic assemblies including an embedded optical connector die 400. The embedded optical connector die 400 comprises a segment of an optical path. The embedded optical connector die 400 comprises at least one optical element, which may comprise an optical deflector and/or at least one optical lens. The various embodiments of the present disclosure may be used to provide versatile various COUPE structures.

The foregoing outlines features of several embodiments so that those skilled in the art may better understand the aspects of the present disclosure. Each embodiment described using the term “comprises” also inherently discloses additional embodiments in which the term “comprises” is replaced with “consists essentially of” or with the term “consists of,” unless expressly disclosed otherwise herein. Whenever two or more elements are listed as alternatives in a same paragraph of in different paragraphs, a Markush group including a listing of the two or more elements is also impliedly disclosed. Whenever the auxiliary verb “can” is used in this disclosure to describe formation of an element or performance of a processing step, an embodiment in which such an element or such a processing step is not performed is also expressly contemplated, provided that the resulting apparatus or device can provide an equivalent result. As such, the auxiliary verb “can” as applied to formation of an element or performance of a processing step should also be interpreted as “may” or as “may, or may not” whenever omission of formation of such an element or such a processing step is capable of providing the same result or equivalent results, the equivalent results including somewhat superior results and somewhat inferior results. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic assembly comprising a composite die, wherein the composite die comprises:
a photonic integrated circuits (PIC) die comprising waveguides and photonic devices therein;
an electronic integrated circuits (EIC) die comprising semiconductor devices therein; and
an embedded optical connector die contacting a top surface of the PIC die and laterally spaced from the EIC die.

2. The photonic assembly of claim 1, wherein the embedded optical connector die comprises an optical deflector that is configured to change a beam direction between a vertically-extending portion of a beam path within the composite die and a horizontally-extending beam path within a first waveguide in the embedded optical connector die.

3. The photonic assembly of claim 2, wherein the vertically-extending portion of the beam path is located entirely outside the PIC die.

4. The photonic assembly of claim 1, wherein the embedded optical connector die comprises at least one optical lens located in a vertically-extending portion of a beam path in the composite die.

5. The photonic assembly of claim 4, wherein the PIC die comprises an optical deflector configured to change a beam direction between the vertically-extending portion of the beam path and a horizontally-extending beam path within a horizontally-extending waveguide in the PIC die.

6. The photonic assembly of claim 1, further comprising a dielectric matrix laterally surrounding the embedded optical connector die and contacting a sidewall of the EIC die.

7. The photonic assembly of claim 2, wherein the composite die comprises a support semiconductor substrate overlying the EIC die and the embedded optical connector die.

8. The photonic assembly of claim 7, wherein a vertically-extending portion of a beam path extends through the support semiconductor substrate.

9. The photonic assembly of claim 7, wherein the embedded optical connector die contacts a bottom surface of the support semiconductor substrate.

10. A photonic assembly comprising a composite die, wherein the composite die comprises:
a photonic integrated circuits (PIC) die comprising waveguides and photonic devices therein;
an electronic integrated circuits (EIC) die comprising semiconductor devices therein;
a support semiconductor substrate overlying the PIC die and the EIC die, wherein the composite die is configured to provide a beam path that extends through the support semiconductor substrate; and
an embedded optical connector die comprising an optical element located within, or at a terminal of the beam path.

11. The photonic assembly of claim 10, wherein the optical element comprises an optical deflector that is configured to change a beam direction between a vertically-extending portion of the beam path within the composite die and a horizontally-extending beam path within a first waveguide in the embedded optical connector die.

12. The photonic assembly of claim 10, wherein the optical element comprises at least one optical lens configured to focus a light beam within a vertically-extending portion of the beam path.

13. The photonic assembly of claim 10, wherein:
the embedded optical connector die comprises first metallic bonding pads embedded within dielectric material layers of the embedded optical connector die; and
the PIC die comprises second metallic bonding pads that are bonded to the first metallic bonding pads by metal-to-metal bonding.

14. The photonic assembly of claim 10, wherein:
a top surface of the EIC die contacts a first segment of a bottom surface of the support semiconductor substrate; and
a top surface of the embedded optical connector die contacts a second segment of the bottom surface of the support semiconductor substrate.

15. The photonic assembly of claim 14, wherein:
a bottom surface of the EIC die contacts a first segment of a top surface of the PIC die;
a bottom surface of the embedded optical connector die contacts a second segment of the top surface of the PIC die; and
the EIC die is laterally surrounded by a dielectric matrix that contacts a sidewall of the EIC die.

16. A method of forming a photonic assembly, the method comprising:
providing a photonic integrated circuits (PIC) die comprising waveguides and photonic devices therein;
bonding an electronic integrated circuits (EIC) die comprising semiconductor devices therein to the PIC die;
attaching an optical connector die comprising an optical element to the PIC die; and
forming a dielectric matrix around the optical connector die on a sidewall of the EIC die.

17. The method of claim 16, further comprising attaching a support semiconductor substrate to an assembly including the EIC die, the optical connector die, and the dielectric matrix.

18. The method of claim 17, wherein:
a first optical lens is embedded on a first side of the support semiconductor substrate that faces the assembly; and
a second optical lens is embedded on a second side of the support semiconductor substrate that is an opposite side of the first side.

19. The method of claim 16, wherein the optical element comprises an optical deflector that is configured to change a beam direction between a vertically-extending portion of a beam path within a composite die and a horizontally-extending beam path within a first waveguide in the embedded optical connector die.

20. The method of claim 16, wherein:
the optical element comprises at least one optical lens configured to focus a light beam within a vertically-extending portion of a beam path; and
the PIC die comprises an optical deflector located at an end of the vertically-extending portion of the beam path and is configured to change a beam direction between the vertically-extending portion of the beam path and a horizontally-extending beam path within a waveguide in the PIC die.
